(19) United States
(12) Patent Application Publication
(10) Pub. No.: US 2018/0234764 A1
(43) Pub. Date: Aug. 16, 2018

(54) ULTRA-LOW-POWER AND LOW NOISE MICROPHONE FOR ACOUSTIC COMMUNICATION

(71) Applicant: WIZEDSP LTD., TEL-AVIV (IL)

(72) Inventor: OZ GABAI, TEL-AVIV (IL)

(21) Appl. No.: 15/750,230

(22) PCT Filed: Aug. 4, 2016
(86) PCT No.: PCT/IB2016/054719

§ 371 Date: Feb. 5, 2018

Related U.S. Application Data
(60) Provisional application No. 62/201,475, filed on Aug. 5, 2015.

(51) Int. Cl. H04R 3/10

(52) U.S. Cl. CPC H04R 3/10; H04R 2201/003

(57) ABSTRACT

A microphone system including a JFET or MOSFET transistor, an input-impedance-network with one terminal connected to the transistor's gate, a resistor connected to the transistor's source and another terminal connected to ground, with bypass capacitor connected in parallel to the resistor, a load resistor connected between the transistor's drain and low-voltage connected, an inverted voltage connected to an op-amplifier, a switch where each throw is connected to a different Vref, one input of the op-amplifier connected to the transistor's source through a bidirectional LPF, a second input connected to the switch pole, a power terminals connected to the inverted voltage and main supply voltage, an output terminal connected to a second terminal of the input impedance network through a second LPF, and an input electrets capacitor source connected in parallel to the input impedance network.

### CROSS-REFERENCE TO RELATED APPLICATIONS

This application claims the benefit of U.S. Provisional Application No. 62/201,475, filed Aug. 5, 2015, the disclosure of which is incorporated herein by reference in its entirety.

### FIELD

The method and apparatus disclosed herein are related to the field of acoustic sensors, and particularly microphones, and, more particularly but not exclusively, to ultra-low-power and ultra-low-noise microphones, and/or microphone buffer.

### BACKGROUND

Microphones are used nearly anywhere. Bluetooth earpiece devices, wired ear piece devices, and toys include microphones. A smartphone may include three microphones.

In recent years, more and more devices are being connected to the internet, such as air conditioners, washing machines, TVs, electric water boilers, etc. Connecting a device to the internet has many advantages. For example money may be saved by using home appliances such as electric water boiler, washing machine, and drying machine using power saving rates, which may vary from place to place and from time to time according to local demand. A smart washing machine may contact the server of the electric utility company via the internet to receive rates as a function of time/day, and then activate the machine during low-cost residential electricity time.

The “brain” of such home appliances may be running in Internet servers, using complex neural network and artificial intelligence algorithms, to smartly activate the home appliances. Sensors installed throughout the house may report to this “brain” through the internet, to further save time and money.

Even further, a local electricity generator, such as a solar panel, may charge a house battery when the house demand is low, and release power when demand and prices are high. Such battery based generator may connected to the internet to retrieve the current price of electricity and optimize its operation.

Such functions are part of the “Internet of Things” (IoT) or Internet of Everything (IoE). Some of the benefits of connecting a device to the internet are:

Web-based smart control the device

Remote monitoring and remote control, by any computational device, everywhere.

Improving and optimizing the service provided by the utility, by collecting and analyzing information received from the usage of each device, sown to devices such as a tooth brush or a screw driver.

Increasing competition and getting better prices for products and services.

The technology is rapidly advancing every day, and some have forecasted that by 2020, more than 50,000,000,000 devices may be connected to the internet. Some of these devices will probably be: Light bulbs, light switches, air conditions, tools such as screwdrivers, tooth brushes, medical devices such as potable blood pressure, books and toys.

It is clear that some IoT, or IoE devices that may be connected to the internet, may have a local power source. These IoT devices can use Wi-Fi, Bluetooth (BT), ZigBee or any other wireless standards, as well as power line communications, to connect the device to the home local router and the internet. Some devices such as glasses, tools, clothes, bathroom portable devices such as toothbrushes, and toys, may require batteries as an energy source.

Wireless communication using electromagnetic radio frequency communication may consume battery power too fast. To reduce battery power consumption a wireless device may be turn automatically off, and then periodically turn on for a short time, to check for incoming messages.

Alternatively, a wireless battery-operated device may use a wakeup receiver to detect the presence of energy in a particular communication band, and then checks if the energy includes a valid marker. If such marker exist the receiver then wake-up the entire device. This two-step process may save a lot of power, as the marker check is done only when a signal is detected. However, in the ISM band or in a radio frequency band is noisy, and therefore such two-step implementation is difficult, particularly when using high bandwidth.

There is thus a widely recognized need for, and it would be highly advantageous to have, a system and method for acoustic sensors that overcomes the above limitations.

### SUMMARY

According to one exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a switch including one pole and at least two throws, where each throw is connected to a different Vref voltage, the op-amplifier including a first input terminal connected to the source terminal of the transistor through a bi-directional low pass filter, a second input terminal connected to the pole of the switch, a first power supply terminal connected to the inverted voltage, a second supply terminal connected to main supply voltage, and an output terminal connected to a second terminal of the input impedance network through a second low pass filter, and an input electrets capacitor source connected in parallel to the input impedance network.

According to another exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low voltage power supply VCC_LOW connected to a second terminal of the load resistor, an inverted voltage −VEE connected to a first power supply node of an op amplifier, and a MEMS bias voltage VBB, a switch including one pole and at least two throws, where each throw is connected to a different Vref voltage, the op-amplifier including a first input terminal connected to the source terminal of the transistor through a bi-directional low pass filter, a second input terminal connected to the pole of the switch, a first power supply terminal connected to the inverted voltage, a second supply terminal connected to main supply voltage, and an output terminal connected to a second terminal of the input impedance network through a second low pass filter, and an input source including a MEMS capacitor including a first terminal connected to ground, and a second terminal connected to a first terminal of a MEMS bias network, a MEMS bias network including a second terminal connected to a bias voltage (VBB), and a coupling capacitor including a first terminal connected to a second terminal of the MEMS capacitor, a second terminal connected to the gate terminal of the transistor.

According to yet another exemplary embodiment, there is provided a method, and a device providing a microphone including a transistor including at least one of a JFET transistor and a MOSFET transistor, an input-impedance-network including a first terminal connected to a gate terminal of the transistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a switch including one pole and at least two throws, where each throw is connected to a different Vref voltage, the op-amplifier including a first input terminal connected to a second (voltage) terminal of the RD resistor through a bi-directional low pass filter, a second input terminal connected to the pole of the switch, a first power supply terminal connected to the inverted voltage, a second supply terminal connected to main supply voltage, and an output terminal connected to a second terminal of the input impedance network through a second low pass filter, and an input electrets capacitor source connected in parallel to the input impedance network.

According to still another exemplary embodiment, there is provided a method, and a device providing a microphone including a transistor including at least one of a JFET transistor and a MOSFET transistor, an input-impedance-network including a first terminal connected to a gate terminal of the transistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a switch including one pole and at least two throws, where each throw is connected to a different Vref voltage, the op-amplifier including a first input terminal connected to a second (voltage) terminal of the RD resistor through a bi-directional low pass filter, a second input terminal connected to the pole of the switch, a first power supply terminal connected to the inverted voltage, a second supply terminal connected to main supply voltage, and an output terminal connected to a second terminal of the input impedance network through a second low pass filter, and an input source including a MEMS capacitor including a first terminal connected to ground, and a second terminal connected to a first terminal of a MEMS bias network, a MEMS bias network including a second terminal connected to a bias voltage (VBB), and a coupling capacitor including a first terminal connected to a second terminal of the MEMS capacitor, a second terminal connected to the gate terminal of the transistor.

Further according to another exemplary embodiment, the input impedance network includes a plurality of low-leakage diodes connected in series where a cathode terminal of a first diode of the plurality of low-leakage diodes is the first terminal of the input impedance network, an anode terminal of the first diode is connected to a cathode terminal of a second diode of the plurality of low-leakage diodes, and an anode terminal of a last diode of the plurality of low-leakage diodes connected in series is the second terminal to the input impedance network.

Yet further according to another exemplary embodiment the input impedance network includes a plurality of low-leakage diodes connected in series where an anode terminal of a first diode of the plurality of low-leakage diodes is the first terminal of the input impedance network, a cathode terminal of the first diode is connected to a cathode terminal of a second diode of the plurality of low-leakage diodes, and a cathode terminal of a last diode of the plurality of low-leakage diodes connected in series is the second terminal to the input impedance network.

Still further according to another exemplary embodiment the input impedance network includes a first plurality of diodes connected in series where a cathode terminal of a first diode of the first plurality of diodes is the first terminal of the input impedance network, an anode terminal of the first diode is connected to a cathode terminal of a second diode of the first plurality of diodes, and an anode terminal of a last diode of the first plurality of diodes is the second terminal to the input impedance network, and a second plurality of diodes connected in series where an anode terminal of a first diode of the second plurality of diodes is connected to the first terminal of the input impedance network, a cathode terminal of the first diode is connected to a cathode terminal of a second diode of the second plurality of diodes, and a cathode terminal of a last diode of the second plurality of diodes is connected to the second terminal to the input impedance network.

Additionally, according to another exemplary embodiment, the input impedance network includes at least two two-terminal sub-networks connected in series where a first terminal of a first sub-network is the first terminal of the input impedance network, a second terminal of a last sub-network is the second terminal of the input impedance network, and a sub-network includes two identical low-leakage diodes connected in parallel and in opposite polarity.

According to yet another exemplary embodiment the MEMS bias network includes a plurality of low-leakage diodes connected in series where a cathode terminal of a first diode of the plurality of low-leakage diodes is the first terminal of the MEMS bias network, an anode terminal of the first diode is connected to a cathode terminal of a second diode of the plurality of low-leakage diodes, and an anode terminal of a last diode of the plurality of low-leakage diodes connected in series is the second terminal to the MEMS bias network.

According to still another exemplary embodiment the MEMS bias network includes a plurality of low-leakage diodes connected in series where an anode terminal of a first diode of the plurality of low-leakage diodes is the first terminal of the MEMS bias network, a cathode terminal of the first diode is connected to a cathode terminal of a second diode of the plurality of low-leakage diodes, and a cathode terminal of a last diode of the plurality of low-leakage diodes connected in series is the second terminal to the MEMS bias network.

Further according to another exemplary embodiment the MEMS bias network includes a first plurality of diodes connected in series where a cathode terminal of a first diode of the first plurality of diodes is the first terminal of the MEMS bias network, an anode terminal of the first diode is connected to a cathode terminal of a second diode of the first plurality of diodes, and an anode terminal of a last diode of the first plurality of diodes is the second terminal to the MEMS bias network, and a second plurality of diodes connected in series where an anode terminal of a first diode of the second plurality of diodes is connected to the first terminal of the MEMS bias network, a cathode terminal of the first diode is connected to a cathode terminal of a second diode of the second plurality of diodes, and a cathode terminal of a last diode of the second plurality of diodes is connected to the second terminal to the MEMS bias network.

Still further according to another exemplary embodiment the MEMS bias network includes at least two two-terminal sub-networks connected in series where a first terminal of a first sub-network is the first terminal of the MEMS bias network, a second terminal of a last sub-network is the second terminal of the MEMS bias network, and a sub-network includes two identical low-leakage diodes connected in parallel and in opposite polarity.

Yet further according to another exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a feed-forward bias-voltage-supply circuit including a first input connected to the first terminal of the source resistor, a second input, where bias is determined, a third input connected to main power supply, a fourth input connected to the inverted voltage, and a first output connected to a second terminal of the input impedance network, and an input electrets capacitor source connected in parallel to the input impedance network.

Even further according to another exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low voltage power supply VCC_LOW connected to a second terminal of the load resistor, an inverted voltage −VEE connected to a first power supply node of an op amplifier, and a MEMS bias voltage VBB, a feed forward bias voltage including a first input connected to the first terminal of the source resistor, a second input, where bias is determined, a third input connected to main power supply, a fourth input connected to the inverted power supply, and a first output connected to a second terminal of the input impedance network, and an input source including a MEMS capacitor including a first terminal connected to ground, and a second terminal connected to a first terminal of a MEMS bias network, a MEMS bias network including a second terminal connected to a bias voltage (VBB), and a coupling capacitor including a first terminal connected to a second terminal of the MEMS capacitor, a second terminal connected to the gate terminal of the transistor.

Additionally, according to another exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a feed-forward bias-voltage-supply circuit including a first input connected to the first (voltage) terminal of the load resistor (RD), a second input where bias is determined, a third input connected to the power supply, a fourth input connected to the inverted voltage, a first output connected to a second terminal of the input impedance network, and an input electrets capacitor source connected in parallel to the input impedance network.

According to still another exemplary embodiment, there is provided a method, and a device providing a microphone including a transistor including at least one of a JFET transistor and a MOSFET transistor, an input-impedance-network including a first terminal connected to a gate terminal of the transistor, a source resistor including a first terminal connected to a source terminal of the transistor, and a second terminal connected to a ground terminal, a bypass capacitor (CS) connected in parallel to the source resistor, a load resistor (RD) including a first terminal connected to a drain terminal of the transistor, a charge-pump generating a low-voltage (VCC_LOW) connected to a second terminal of the load resistor, and an inverted voltage (−VEE) connected to a first power supply node of an op amplifier, a feed-forward bias-voltage-supply circuit including a first input connected to the first (voltage) terminal of the load resistor (RD), a second input where bias is determined, a third input connected to the power supply, a fourth input connected to the inverted voltage, a first output connected to a second terminal of the input impedance network, and an input source including a MEMS capacitor including a first terminal connected to ground, and a second terminal connected to a first terminal of a MEMS bias network, a MEMS bias network including a second terminal connected to a bias voltage (VBB), and a coupling capacitor including a first terminal connected to a second terminal of the MEMS capacitor, a second terminal connected to the gate terminal of the transistor.

According to yet another exemplary embodiment the microphone additionally includes a second terminal of the feed-forward bias-voltage-supply circuit connected to the charge pump.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a wakeup receiver;

FIG. 2 is a simplified flow chart of a state machine of a transceiver;

FIG. 3 is a simplified illustration of a microphone element connected to a microphone buffer based on a JFET transistor;

FIG. 4 is a simplified illustration of an AC equivalent circuit for noise/gain analysis of the circuit of FIG. 3;

FIG. 5 is a simplified illustration of Eliminating RG in the buffer and decreasing noise due to leakage;

FIG. 6 is a simplified illustration of Eliminating RG in the buffer and decreasing noise due to leakage;

FIG. 7 is a simplified illustration of Eliminating RG in the buffer and decreasing noise due to leakage;

FIG. 8 is a simplified illustration of Eliminating RG in the buffer and decreasing noise due to leakage;

FIG. 9 is an AC and noise equivalent circuit of FIG. 5;

FIG. 10 is a simplified illustration of AC and noise equivalent circuit of FIG. 7;

FIG. 11 is a simplified electric schematic illustrating the distortion due to the diodes network;

FIG. 12 is a simplified electric schematic of an Electret Condenser Microphone (ECM) ultra-low-noise ultra-low-power microphone with feedback from source;

FIG. 13 is a simplified electric schematic of an equivalent circuit of the ECM;

FIG. 14 is a simplified electric schematic of an Electret Condenser Microphone (ECM) ultra-low-noise ultra-low-power microphone with feedback from drain;

FIG. 15 is a simplified electric schematic of a Micro Electrical Mechanical System Microphone ultra-low-noise ultra-low-power microphone with feedback from source;

FIG. 16 is a simplified electric schematic of a Micro Electrical Mechanical System Microphone ultra-low-noise ultra-low-power microphone with feedback from drain;

FIG. 17 is a simplified illustration of a low-noise VBB biasing circuit; and

FIG. 18 is a simplified block diagram of a fast biasing circuit.

### DETAILED DESCRIPTION

The invention in embodiments thereof comprises a method and/or a device including an acoustic sensor, and particularly a microphone, and, more particularly but not exclusively, an ultra-low-power and ultra-low-noise microphone, and/or microphone buffer.

The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different figures may use different scales and different scales can be used even within the same drawing, for example different scales for different views of the same object or different scales for the two adjacent objects.

The purpose of the embodiments is to provide at least one system and/or method for sensing acoustic signals, and particularly a microphone and/or microphone buffer, operating in ultra-low-power, and/or an ultra-low-noise mode.

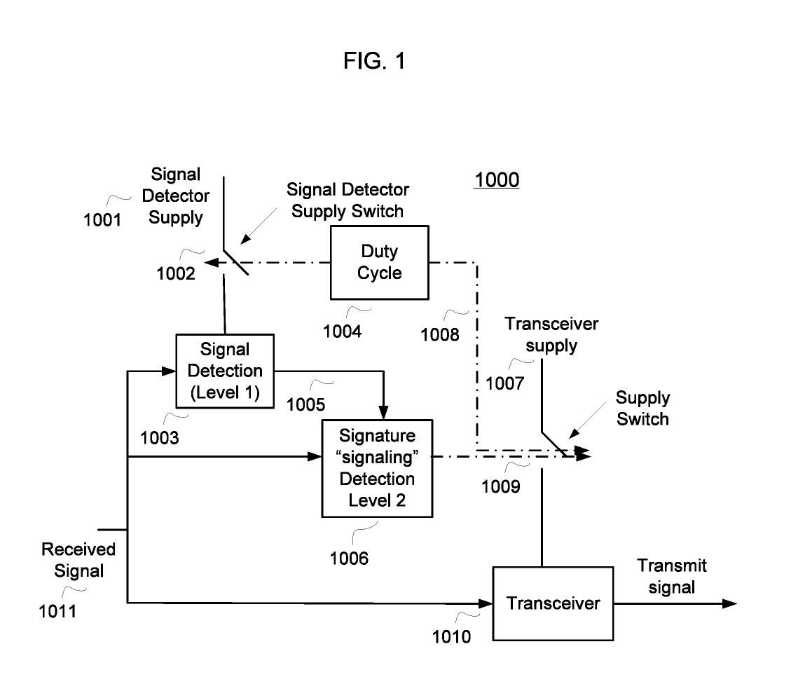

FIG. 1 is a simplified illustration of a wakeup receiver 1000, according to one exemplary embodiment.

Wakeup receiver 1000 may include a signal supply 1001, which may be connected to signal detection level-1 1003 for detection of signal presence 1011 at some bandwidth. If such signal exist, signal detection level-1 1003 emits signal 1005, which turns on a signature/valid marker detection circuit 1006. This circuitry may consume relatively high power. If the marker is valid signal 1009 switches on a transceiver power supply 1007, turning on the transceiver 1010. Alternatively, the wakeup receiver can periodically turn on the signal detection power supply using signal 1002. This completes the testing of presence of signal 1011.

A wakeup receiver based on periodical turn-on (as implemented in Bluetooth low energy (BLE)) may cause delayed response, and may still consume relatively high power. Such circuitry powered by a CR2032 battery may last for 8-14 months. Considering that a CR2032 battery is too large for typical IoT devices such as glasses, button of pens or shirt, or a tooth brush, this circuitry becomes useless.

An alternative circuitry uses an envelope detector, which suffers from a large the number of false alarm, as the ISM bands is highly populates, again consuming much power. It is noted that implementing a bandwidth signal presence envelope detector is not be easy.

Still there is a requirement for some devices to work for a few years using a battery much smaller than the CR2032 (a 235 mAh battery). Acoustic communication can enable such device, particularly using a 14 kHz-20 kHz band divided into sub-bands such as 500 Hz. Acoustic communication is may consume 2000 times less power than RF communication.

A microphone is a typical signal transducer converting acoustic signals to electrical signals. A common microphone may consume 17 μA-500 μA. This, for example, may consume a small battery (e.g., 2.5 mm×2.5 mm×1 mm) providing 1.47 mAh (based on the characteristics of the CR2032 battery) in less than 90 hours.

A good microphone may have Signal to Noise Ratio (SNR) of about 68 dB which limits the communication range. Therefore there is a need to have extremely low power wakeup receiver preferably consuming 50 nWatts-100 nWatts. Using a 3V battery this may mean 17 nA-33 nA, which enables 10 years of operation (for power consumption of 50 nWatts).

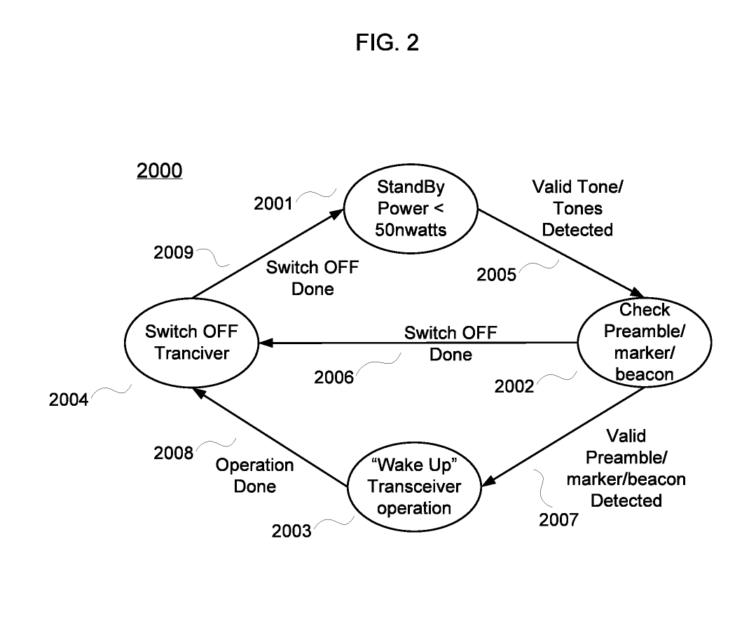

FIG. 2 is a simplified flow chart of a state machine 2000 of a transceiver, according to one exemplary embodiment.

As shown in FIG. 2, state machine 2000 may include a standby state 2001 typically consuming about 50 nWatts. In the standby state an acoustic signal is searched using an ultra-low-power microphone, and an ultra-low-power signal detection circuit, using the extremely low frequency of the acoustic signal. When an acoustic signal presence is detected 2005, the state machine moves to a second state 2002 to check whether a preamble/marker/beacon signal exists. If the case of a false alarm 2006, the state machine transits to a switch-off state 2004, sends a switch-off signal 2009, and returns to the standby state 2001. If the preamble/marker/beacon is valid 2007, the acoustic transceiver wakes-up and the state machine transits to the wakeup state 2003, where the transceiver performs the required operation.

It is appreciated that a typical IoT or IoE device may work on-demand only, and therefore transceivers a typical IoT or IoE device are most of the time in standby state 2001.

An acoustic wakeup signal may be a tone (e.g., an acoustic wave of a particular frequency) or combinations of tones. This may enable different wakeup signals for different devices. For example, remote controlled lighting fixtures may be wakeup by a particular tone (e.g., WAKEUP_SIG1) that may enable other acoustic IoT IoE devices to remain in standby. A wakeup signal may include a particular number of tones (e.g., N1 tones), while the payload signal may include a different number of tones (e.g., N2 tones where, for example, N2>>N1).

This may mean that for a transmitter max value A the signal value of each tone while the wakeup signal is transmitted may be

$$\frac{A}{\sqrt{{N}_{1}}}$$

and in payload each tone may have a value of

$$\frac{A}{\sqrt{{N}_{2}}} ,$$

this means that for a constant SNR defined as

$$\frac{Signal\_power}{Noise\_power} .$$

The tone SNR which is defined as the tone power divided by the noise power may be different for the wakeup signal and the payload signal. Assuming discrete Fourier transform of N points, the tone SNR for the wakeup signal is given by Eq. 1 and the tone SNR for the payload signal is given by:

$$\begin{matrix}SNR ( wakeup , tone ) = \frac{N ( \frac{{A}^{2}}{{N}_{1}} )}{{σ}^{2}} = \frac{N}{{N}_{1}} ( \frac{{A}^{2}}{{σ}^{2}} ) & Eq . 1 \\ SNR ( payload , tone ) = \frac{N ( \frac{{A}^{2}}{{N}_{1}} )}{{σ}^{2}} = \frac{N}{{N}_{2}} ( \frac{{A}^{2}}{{σ}^{2}} ) & Eq . 2\end{matrix}$$

It is clear from Eq. 1 and Eq. 2, that the SNR for the two cases is different, therefore to balance the system for the wakeup and payload the microphone may have to have SNR control, therefore the purpose of this patent is to describe a microphone having two states the first which is lower power at standby and the second while the acoustic IoT, IoE device is in receive mode may consume more power.

Microphones as an acoustic input “antenna” may need to have at least two states. Microphones are important as an input device for acoustic audio waves for the increasing market of the smartphones/tablets/cell phones. The new microphones may need to have higher SNR for better acoustic echo canceling and better audio quality in one hand and on the other hand to be extremely low power to allow hands-free acoustic audio activation—like the android “OK Google”.

Moreover, for IoT IoE devices, microphones are important as an “Antenna” converting the acoustic communication signal to electrical signal. To enable many years of battery-based operation these microphones need to consume less power than 50 nWatts, and to provide large communication range. These microphones may need to have SNR better than 70 db, which currently enables communication of up to 20-30 meters using 96 dB SPL signal.

Analysis of the SNR of a typical microphone.

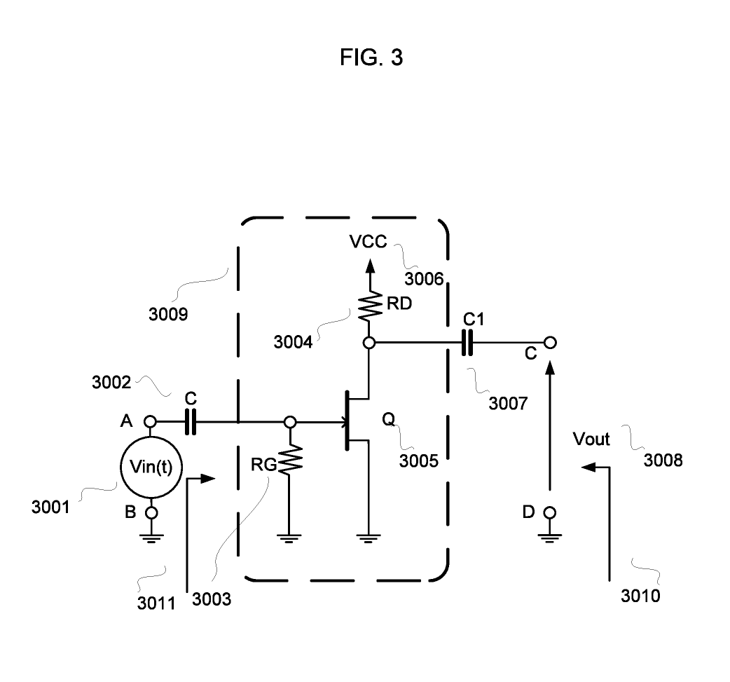

FIG. 3 is a simplified illustration of a microphone element 3001 connected to a microphone buffer based on a JFET transistor, according to one exemplary embodiment.

The microphone element 3001 of FIG. 3 may be regarded as a source of signal typically coupled to a microphone buffer 3009 via a coupling capacitor 3002. The microphone buffer 3009 may include a gate bias resistor RG 3003, an active element 3005 based on a JFET or MOSFET transistor, a load resistor RD 3004 and a power supply VCC 3006. The output is coupled via a coupling capacitor. The buffer 3009, is used to transfer the signal from the acoustic transducer source 3001 while providing low capacitance at the input 3011, and low output impedance at the output 3010.

Noise Gain Analysis of Prior Art Buffer

The following analysis is suitable for an Electret Condenser Microphone (ECM), or a Micro Electronic Mechanical Systems (MEMS) microphone, as well as other types of microphones.

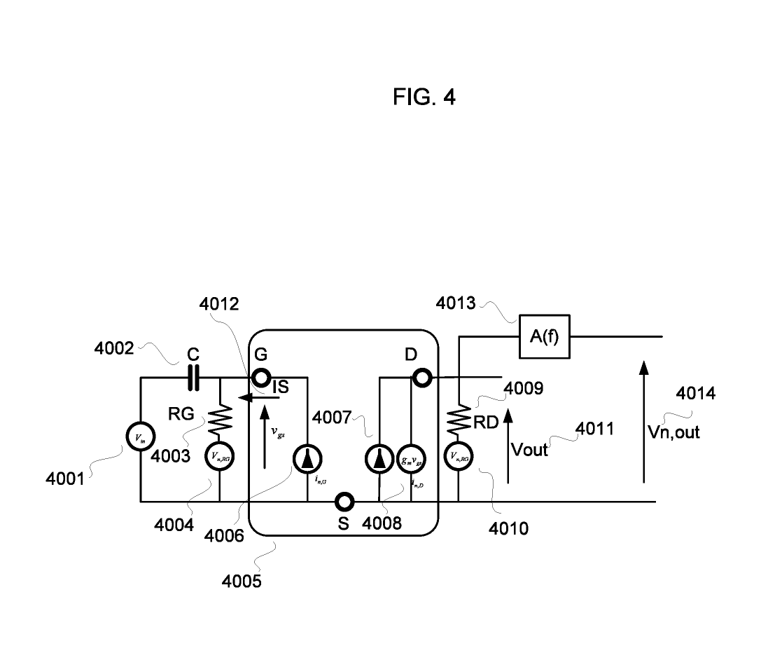

FIG. 4 is a simplified illustration of an AC equivalent circuit for noise/gain analysis of the circuit of FIG. 3, according to one exemplary embodiment.

We assume that the active element 3005, JFET of FIG. 3 is in saturation mode—i.e. where we get gain.

As described by FIG. 4, there are a few noise sources for the circuit of FIG. 3:

RG: Thermal noise from RG 4003, described by a serial voltage source 4004 and the noise is given by:

V_{n,RG}²=4KTR_{G}Δf, Eq. 3

where K is the Boltzmann constant and T is temperature in Kelvin degrees.

RD: Thermal noise from RD 4009, described by a serial voltage source 4004 and the noise is given by:

V_{n,RD}²=4KTR_{D}Δf, Eq. 4

where K is the Boltzmann constant and T is temperature in Kelvin degrees.

Current noise in the drain source—here we neglect the 1/f noise—which appears at very low frequencies, the drain source current noise is given by:

$${i}_{n , d}^{2} = \frac{8}{3} {KTg}_{m} Δ f \qquad Eq . 5$$

Current noise from the gate 4006 and is given by:

i_{n,d}²=2IₛqΔf Eq.6

The noise in microphones is calculated taking into account—so called A weighted filter 4013, this filter 4013, simulates in some sense the human ears frequency response—this response is given by Eq. 7, the output of the filter 4014 denoted by Vn,out.

$$A ( f ) = {10}^{( 2 / 20 )} \frac{{12200}^{2} {f}^{4}}{( {f}^{2} + {20.6}^{2} ) ( {f}^{2} + {12200}^{2} ) \sqrt{( {f}^{2} + {107.7}^{2} ) ( {f}^{2} + {739.7}^{2} )}} \qquad Eq . 7$$

Vout 4010 is given by:

$${v}_{out} = - {g}_{m} {v}_{in} ( \frac{j ω {R}_{G} C}{1 + j ω {R}_{G} C} ) {R}_{D} \qquad Eq . 8$$

While Vn,out 4014 is given by:

$${v}_{n , out} ( f ) \sqrt{Δ f} - {g}_{m} \sqrt{4 {KTR}_{G} Δ f} ( \frac{1}{1 + j ω {R}_{G} C} ) {R}_{D} A ( f ) - - {g}_{m} \sqrt{2 {I}_{s} q Δ f} ( \frac{{R}_{G}}{1 + j ω {R}_{G} C} ) {R}_{D} A ( f ) + {R}_{D} \sqrt{\frac{8}{3} {KTg}_{m} Δ f} A ( f ) + + \sqrt{4 {KTR}_{D} Δ f} A ( f ) \qquad Eq . 9$$

where ω=2πf.

Assuming ωR_{G}C>>1n Eq. 8 and Eq. 9 become:

$$\begin{matrix}{v}_{out} = - {g}_{m} {v}_{in} {R}_{D} & Eq . 10 \\ {v}_{n , out} ( f ) \sqrt{Δ f} \approx - {g}_{m} \sqrt{4 {KTR}_{G} Δ f} ( \frac{1}{j2 π {fR}_{G} C} ) {R}_{D} A ( f ) - - {g}_{m} \sqrt{2 {I}_{s} q Δ f} ( \frac{1}{j2 π fC} ) {R}_{D} A ( f ) + {R}_{D} \sqrt{\frac{8}{3} {KTg}_{m} Δ f} A ( f ) + + \sqrt{4 {KTR}_{D} Δ f} A ( f ) & Eq . 11\end{matrix}$$

To compute the Root Mean Square noise, one should add the RMS noise elements in a df bandwidth on f1=0 Hz to f2=20000 Hz or:

$${v}_{n , out}^{2} = {{\int }_{{f}_{1}}}^{{f}_{2}} {\vert {v}_{n , out} ( f ) \vert}^{2} df == {g}_{m}^{2} 4 {KTR}_{D}^{2} ( \frac{1}{4 {π}^{2} {R}_{G} {C}^{2}} ) {{\int }_{{f}_{1}}}^{{f}_{2}} \frac{{\vert A ( f ) \vert}^{2}}{{f}^{2}} df + + {g}_{m}^{2} 2 {I}_{S} {qR}_{D}^{2} ( \frac{1}{4 {π}^{2} {C}^{2}} ) {{\int }_{{f}_{1}}}^{{f}_{2}} \frac{{\vert A ( f ) \vert}^{2}}{{f}^{2}} df + + \frac{8}{3} {KTg}_{m} {R}_{D}^{2} {{\int }_{{f}_{1}}}^{{f}_{2}} {\vert A ( f ) \vert}^{2} df + 4 {KTR}_{D} {{\int }_{{f}_{1}}}^{{f}_{2}} {\vert A ( f ) \vert}^{2} df \qquad Eq . 12$$

Or if

$${ξ}_{1} = {{\int }_{{f}_{1}}}^{{f}_{2}} \frac{{\vert A ( f ) \vert}^{2}}{{f}^{2}} df , {ξ}_{2} = {{\int }_{{f}_{1}}}^{{f}_{2}} {\vert A ( f ) \vert}^{2} df \qquad Eq . 13$$

Therefore:

$${v}_{n , out}^{2} = {{\int }_{{f}_{1}}}^{{f}_{2}} {\vert {v}_{n , out} ( f ) \vert}^{2} df == {g}_{m}^{2} 4 {KTR}_{D}^{2} ( \frac{1}{4 {π}^{2} {R}_{G} {C}^{2}} ) {ξ}_{1} + {g}_{m}^{2} 2 {I}_{S} {qR}_{D}^{2} ( \frac{1}{4 {π}^{2} {C}^{2}} ) {ξ}_{1} + + \frac{8}{3} {KTg}_{m} {R}_{D}^{2} {ξ}_{2} + 4 {KTR}_{D} Δ f {ξ}_{2} \qquad Eq . 14$$

For f1=0 Hz, f2=20000 Hz one can show using Eq. 7 that:

ξ₁=0.0026,ξ₂=12474 Eq. 15

As the gain is defined by G=gₘR_{D} then Eq. 14 may be written as

$${v}_{n , out}^{2} = {{\int }_{{f}_{1}}}^{{f}_{2}} {\vert {v}_{n , out} ( f ) \vert}^{2} df = {G}^{2} 4 KT ( \frac{1}{4 {π}^{2} {R}_{G} {C}^{2}} ) {ξ}_{1} + {G}^{2} 2 {I}_{S} q ( \frac{1}{4 {π}^{2} {C}^{2}} ) {ξ}_{1} + + G \frac{8}{3} {KTR}_{D} {ξ}_{2} + 4 {KTR}_{D} {ξ}_{2} \qquad Eq . 16$$

And the noise equivalent at the input is:

$${v}_{n , in}^{2} = \frac{{v}_{n , out}^{2}}{{G}^{2}} = \frac{1}{{G}^{2}} {{\int }_{{f}_{1}}}^{{f}_{2}} {\vert {v}_{n , out} ( f ) \vert}^{2} df == 4 KT ( \frac{1}{4 {π}^{2} {R}_{G} {C}^{2}} ) {ξ}_{1} + 2 {I}_{S} q ( \frac{1}{4 {π}^{2} {C}^{2}} ) {ξ}_{1} + \frac{8}{3 G} {KTR}_{D} {ξ}_{2} + \frac{4 {KTR}_{D} {ξ}_{2}}{{G}^{2}} \qquad Eq . 17$$

Analysis of noise terms

For

$$4 KT ( \frac{1}{4 {π}^{2} {R}_{G} {C}^{2}} ) {ξ}_{1}$$

it is clear that having large C and large RG will decrease the noise. However for ECM or MEMS microphones C=5 pF-10 pF due to the small size of RG (typically 25 MOhm-100 MOhm).

Therefore, for a microphone with RG=100M—

$$\sqrt{4 KT ( \frac{1}{4 {π}^{2} {R}_{G} {C}^{2}} ) {ξ}_{1}} = 10.4 uv \qquad Eq . 18 A$$

Increasing RG to 1 GOhm may give a noise of about 3μζ and for microphone sensitivity of −38 dBv=12.6 mV the reflected SNR (not taking into account other terms) from this noise is

$$20 {log}_{10} ( \frac{12.6 mv / \sqrt{2}}{3 uv} ) = 69.45 dB .$$

Table 1 and table 1a summarizes the A weighted noise and SNR for various C and RG values.

TABLE 1
Equivalent A weighted noise at the input induced by Rg for various Rg
and C values

| | C | | | | |
|---|---|---|---|---|---|
| Rg | 5 pF | 10 pF | 30 pF | 56 pF | 100 pF |
| 25 MOhm | 41.77 μV | 20.89 μV | 6.96 μV | 37.3 μV | 2.09 μV |
| 100 MOhm | 20.89 μV | 10.44 μV | 3.48 μV | 18.6 μV | 1.04 μV |
| 1 GOhm | 6.6 μV | 3.3 μV | 1.1 μV | 5.9 μV | 0.33 μV |
| 10 GOhm | 2.09 μV | 1.04 μV | 0.35 μV | 1.9 μV | 0.1 μV |

TABLE 1a
SNR with A weighted noise at the input induced by Rg for various Rg
and C values

| | C | | | | |
|---|---|---|---|---|---|
| Rg | 5 pF | 10 pF | 30 pF | 56 pF | 100 pF |
| 25 MOhm | 46.6 [dB] | 52.6 [dB] | 62.16 [dB] | 67.6 [dB] | 72.6 [dB] |
| 100 MOhm | 52.6 [dB] | 58.6 [dB] | 68.16 [dB] | 73.6 [dB] | 78.6 [dB] |
| 1 GOhm | 62.6 [dB] | 68.6 [dB] | 78.16 [dB] | 83.6 [dB] | 88.6 [dB] |
| 10 GOhm | 72.6 [dB] | 78.6 [dB] | 88.16 [dB] | 93.6 [dB] | 98.6 [dB] |

For

$$2 {I}_{S} q ( \frac{1}{4 {π}^{2} {C}^{2}} ) {ξ}_{1}$$

where Is 4012 is the leakage current. It is clear that having smaller leakage current will decrease the noise from the JFET hate leakage current, C again is 5 pF-10 pF, for Is=1000 pA.

Therefore, one may get:

$$\sqrt{2 {I}_{S} q ( \frac{1}{4 {π}^{2} {C}^{2}} ) {ξ}_{1}} = 14.5 uv \qquad Eq . 18 B$$

And for Is=1 pA one may get 0.46 μV, and for Is=0.2 pA one may get 0.21 μV, for microphone with −38 dBv=12.6 mV sensitivity and IS=1000 pA, 1 pA and 0.2 pA the reflected SNR is:

$$\begin{matrix}Is = 1000 pA & \to & 20 {log}_{10} ( \frac{12.6 mv / \sqrt{2}}{14.5 uv} ) = 55 dB \\ Is = 1 pA & \to & 20 {log}_{10} ( \frac{12.6 mv / \sqrt{2}}{0.46 uv} ) = 85 dB \\ Is = 0.2 pA & \to & 20 {log}_{10} ( \frac{12.6 mv / \sqrt{2}}{0.21 uv} ) = 92.6 dB\end{matrix}$$

Table 2 and table 2a summarizes the input equivalent a weighted noise and the associated SNR for −38 dBv sensitivity.

TABLE 2
Equivalent A weighted noise at the input induced by JFET leakage noise
current for different leakage and C values.

| | C | | | | |
|---|---|---|---|---|---|
| Is | 5 pF | 10 pF | 30 pF | 56 pF | 100 pF |
| 1000 pA | 29.03 μV | 14.52 μV | 4.84 μV | 2.59 μV | 1.45 μV |
| 100 pA | 9.18 μV | 4.59 μV | 1.53 μV | 0.82 μV | 0.46 μV |
| 2 pA | 1.3 μV | 0.65 μV | 0.22 μV | 0.12 μV | 0.06 μV |
| 1 pA | 0.92 μV | 0.46 μV | 0.15 μV | 0.08 μV | 0.05 μV |

TABLE 1a
SNR with A weighted noise at the input induced by JFET leakage noise
current for different leakage and C values.

| | C | | | | |
|---|---|---|---|---|---|
| Rg | 5 pF | 10 pF | 30 pF | 56 pF | 100 pF |
| 1000 pA | 49.74 [dB] | 55.76 [dB] | 65.30 [dB] | 70.72 [dB] | 75.76 [dB] |
| 100 pA | 59.74 [dB] | 65.76 [dB] | 75.30 [dB] | 80.72 [dB] | 85.76 [dB] |
| 2 pA | 76.3 [dB] | 82.75 [dB] | 92.30 [dB] | 97.71 [dB] | 102.75 [dB] |
| 1 pA | 79.74 [dB] | 85.76 [dB] | 95.30 [dB] | 100.72 [dB] | 105.76 [dB] |

For other two terms

$$\frac{8}{3 G} {KTR}_{D} {ξ}_{2} and \frac{4 {KTR}_{D} {ξ}_{2}}{{G}^{2}}$$

we assume a JFET with IDSS=0.5 mA Vp=−1V and RD=1000 Ohm which are typical values (here we neglected the Cgs that gives attenuation at the input by 2 and therefore usually one selects RD=2000 Ohm using this it is clear that

$${g}_{m} = \frac{2}{{V}_{P}} \sqrt{{I}_{D} {I}_{DSS}} = \frac{2 {I}_{DSS}}{{V}_{P}} \{ at {V}_{GS} = 0 \} = 0.001 {( ohm )}^{- 1} , and G = {g}_{m} {R}_{D} = 1.$$

For

$$\frac{8}{3 G} {KTR}_{D} {ξ}_{2}$$

it is clear that smaller RD will decrease the noise as well as larger G, this is possible by increasing the current, for typical ECM or MEMS microphones.

$$\sqrt{\frac{8}{3 G} {KTR}_{D} {ξ}_{2}} = 0.37 uv \qquad Eq . 18 C$$

And for −38 dBv=12.6 mv microphone the reflected SNR here is

$$20 {log}_{10} ( \frac{12.6 mv / \sqrt{2}}{0.37 uv} ) = 87.6 dB ,$$

this number may be easily increased by lowering RD, by using larger IDSS JFET. For example by using JFET with IDSS=5 mA we can use RD=100 Ohm and in this case the SNR will be

$$20 {log}_{10} ( \frac{12.6 mv / \sqrt{2}}{0.123 uv} ) = 97.2 dB .$$

For

$$\frac{4 {KTR}_{D} {ξ}_{2}}{{G}^{2}}$$

it is clear that decreasing RD and increasing G will decrease this term. For a typical ECM or MEMS microphones we may have:

$$\sqrt{\frac{4 {KTR}_{D} {ξ}_{2}}{{G}^{2}}} = 0.45 uv \qquad Eq . 18 D$$

Which for −38 dBv microphone sensitivity reflects an SNR of

$$20 {log}_{10} ( \frac{12.6 mv / \sqrt{2}}{0.45 uv} ) = 85.9 dB$$

as before by decreasing RD by 10 by using JFET with IDSS=5 ma the reflected SNR may be

$$20 {log}_{10} ( \frac{12.6 mv / \sqrt{2}}{0.45 uv} ) = 96 dB .$$

Conclusions:

As one can see the limiting factor for the SNR is the RG, then the leakage current while the last two term are easily decreased by using JFET with larger IDSS and hence smaller RD, on the other hand C may be increased—by putting a parallel to gate and source a second capacitor, that will decrease the noise coming from RG 4003 and the noise due to the leakage IS 4012, the capacitor will give attenuation that may be compensated by increasing the gm trans-conductance of the JFET 4005, by increasing the drain current.

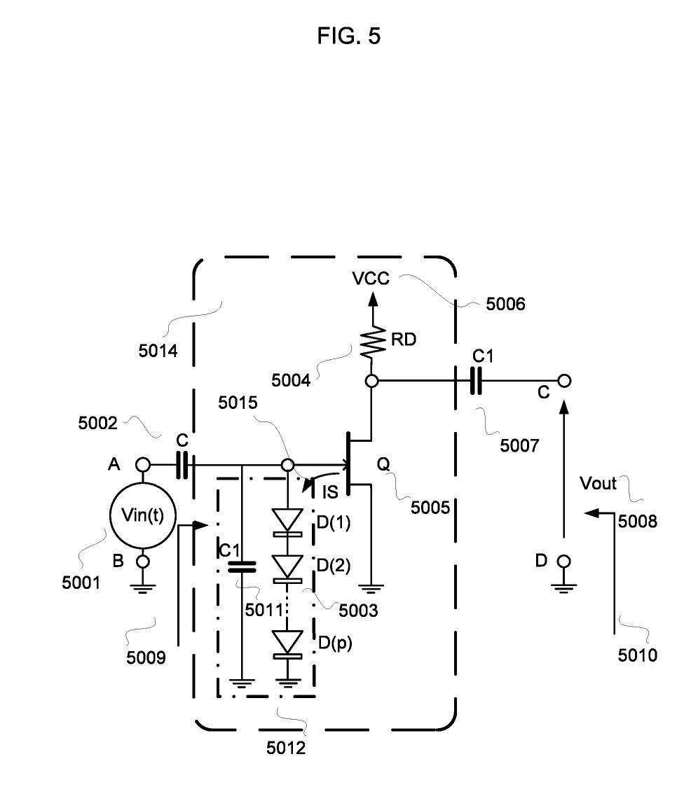

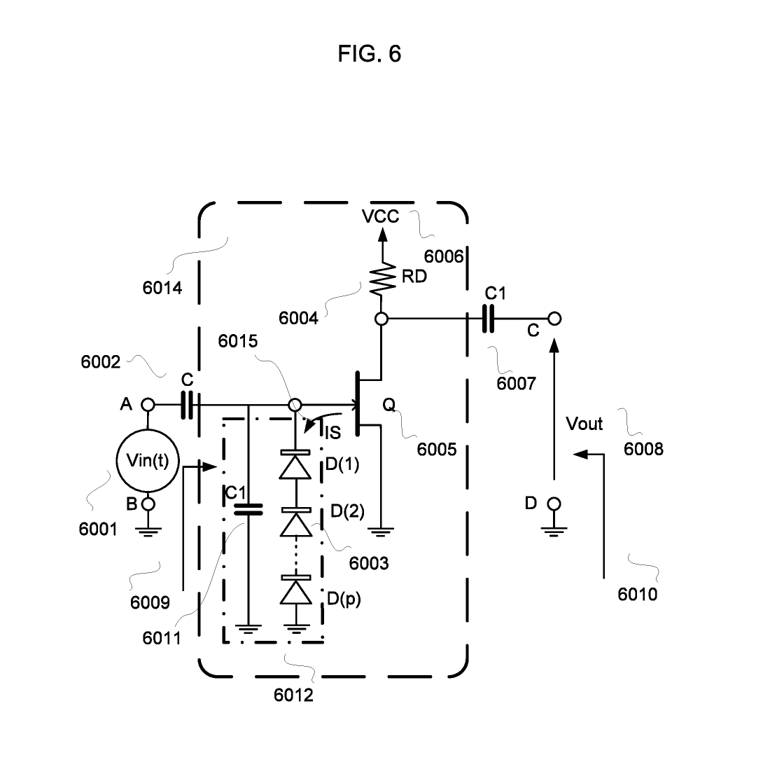

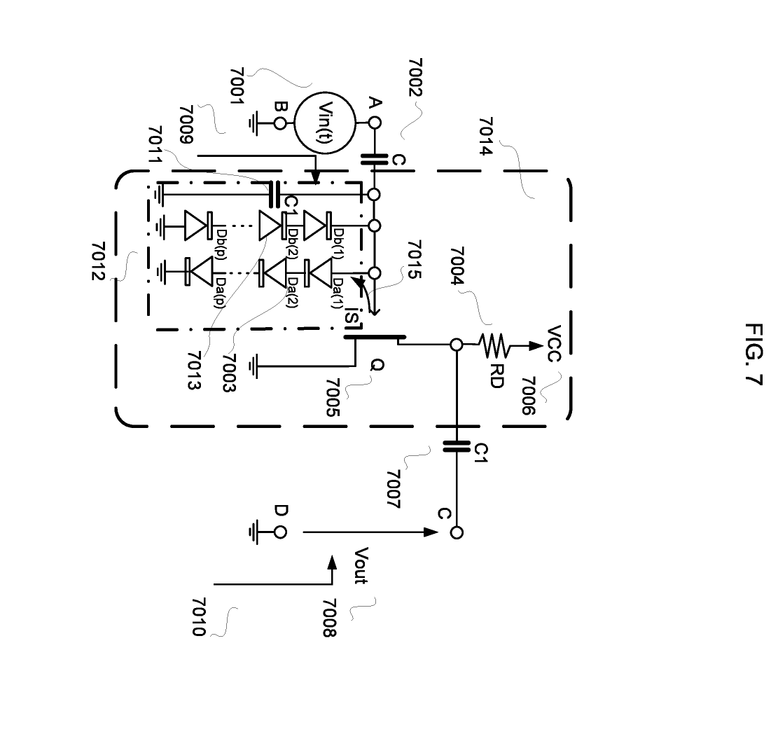

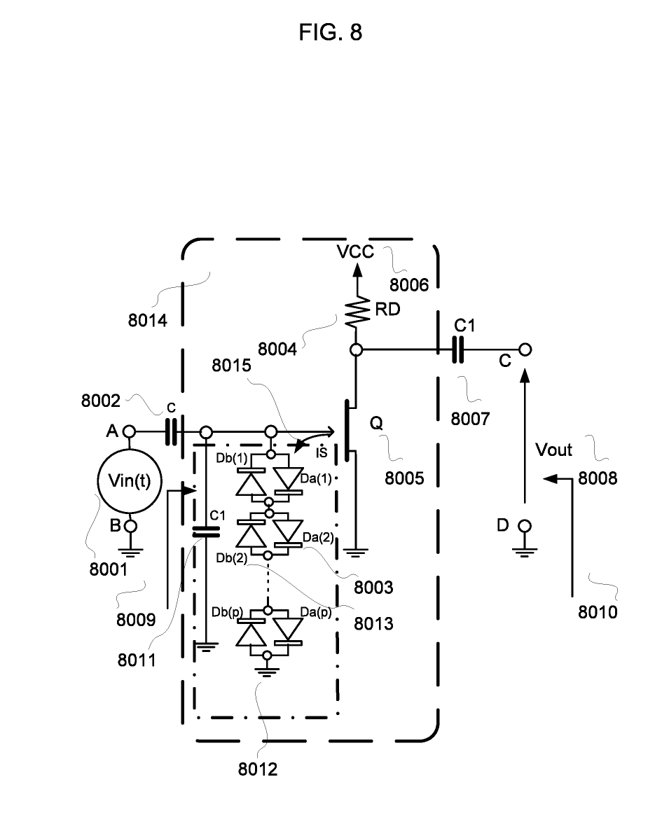

FIG. 5, FIG. 6, FIG. 7 and FIG. 8 describe the solution for the RG problem with a possible parallel capacitor C1.

FIG. 5 is a simplified illustration of Eliminating RG in the buffer and decreasing noise due to leakage (option1), according to one exemplary embodiment.

FIG. 6 is a simplified illustration of Eliminating RG in the buffer and decreasing noise due to leakage (option2), according to one exemplary embodiment.

FIG. 7 is a simplified illustration of Eliminating RG in the buffer and decreasing noise due to leakage (option3), according to one exemplary embodiment.

FIG. 8 is a simplified illustration of Eliminating RG in the buffer and decreasing noise due to leakage (option4), according to one exemplary embodiment.

Circuits of FIG. 5, FIG. 6, FIG. 7 and FIG. 8 are based on a network of diodes 6012, 7012, 8012 and 9012 and capacitor C1 5011, 6011, 7011 and 8011.

Analysis of Serial Diodes Network Connection

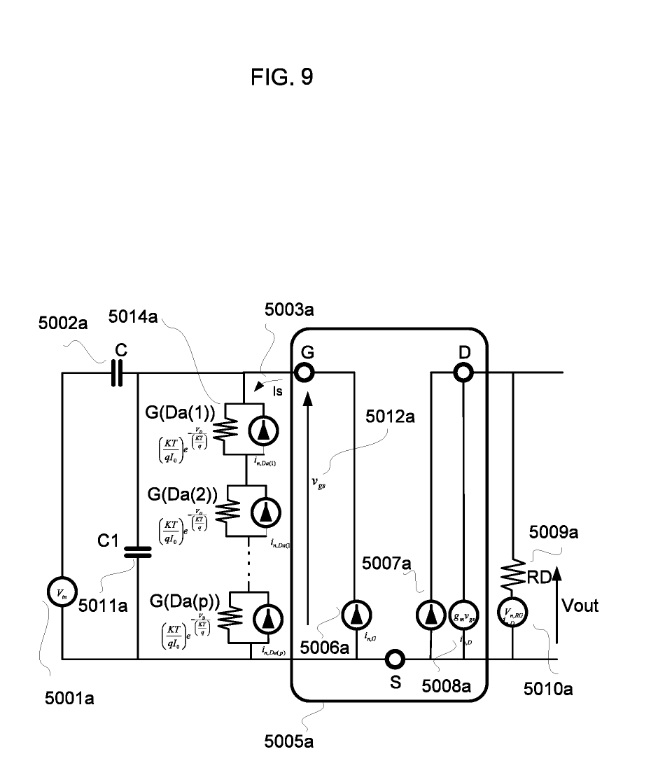

Reference is now made to FIG. 9, which is an AC and noise equivalent circuit of FIG. 5, according to one exemplary embodiment.

The noise of each diode Da(1), Da(2) . . . Da(p) 5003 of FIG. 5 is given by:

i_{n,Da(k)}²=(2Iₛ+I₀)qΔf Eq. 17

Diode Small Signal Resistance

The small signal diode resistance is given by:

$${[ \frac{{I}_{0}}{( \frac{KT}{q} )} {e}^{\frac{{V}_{D}}{( \frac{KT}{q} )}} ]}^{- 1} = ( \frac{KT}{{qI}_{0}} ) {e}^{- \frac{{V}_{D}}{( \frac{KT}{q} )}} \approx ( \frac{KT}{{qI}_{0}} ) {( \frac{KT}{{qV}_{D}} )}_{Forsmall {V}_{D} {V}_{D} << \frac{KT}{q}}$$

If a diode with I₀≈Iₛ is selected then

$${V}_{D ( DC )} = \frac{KT}{q} ln ( 2 ) = 0.69 \frac{KT}{q} = 17.3 {mv}_{at 25 deg}$$

In this case the diode small signal resistance is given by

$$( \frac{KT}{2 {qI}_{S}} )$$

It may be important to select diode that will not have higher leakage current than the Is, which may help reducing diode noise. If I₀≈Iₛ then the DC voltage on the diode may be small, such that putting 10-20 diodes in series may not create a high voltage drop on the diodes.

Diode Current Noise Calculation and Reduction

The reason for connecting serial diodes is to reduce the distortion resulted from using the diode, first we show that connecting a serial diodes actually reduces the total diode noise.

One can transform the diodes 5003, circuit of FIG. 9 using the Thevenin theorem and get the following total current with the following total resistance.

$${i}_{n , diodes} = \frac{\sqrt{\begin{matrix}( 2 {I}_{S} + {I}_{0} ) q Δ {f ( \frac{KT}{2 {qI}_{s}} )}^{2} + \\ ( 2 {I}_{S} + {I}_{0} ) q Δ {f ( \frac{KT}{2 {qI}_{s}} )}^{2} + … + ( 2 {I}_{S} + {I}_{0} ) q Δ {f ( \frac{KT}{2 {qI}_{s}} )}^{2}\end{matrix}}}{p ( \frac{KT}{2 {qI}_{s}} )} = \frac{\sqrt{( 2 {I}_{S} + {I}_{0} ) q Δ f}}{\sqrt{p}} \qquad Eq . 19$$

And the total resistance is

$$p ( \frac{KT}{2 {qI}_{s}} ) .$$

This does not give any thermal noise it is just the slope of the diode current, having C1.

The total current noise is the square sum of the diode noise and the gate leakage noise 5014a and is given by:

$$20 {i}_{n , diodes + jfet}^{2} = \frac{( 2 {I}_{S} + {I}_{0} ) q Δ f}{p} + 2 {I}_{S} q Δ f \approx 2 {I}_{S} q Δ f for p \geq 10 \qquad Eq . 20$$

We can conclude that Eq. 15 now will take the form:

$${v}_{n , in}^{2} = \frac{{v}_{n , out}^{2}}{{G}^{2}} = \frac{1}{{G}^{2}} {\int }_{{f}_{1}}^{{f}_{2}} {\vert {v}_{n , out} ( f ) \vert}^{2} df == 2 {I}_{S} q ( \frac{1}{4 {{π}^{2} ( C + {C}_{1} )}^{2}} ) {ξ}_{1} + \frac{8}{3 G} {KTR}_{D} {{ξ}_{2} [ \frac{( C + {C}_{1} )}{C} ]}^{2} + {\frac{4 {KTR}_{D} {ξ}_{2}}{{G}^{2}} [ \frac{( C + {C}_{1} )}{C} ]}^{2} \qquad Eq . 21$$

One can see from equation 20, that C1 helps with reducing the current noise from the PN junction of the JFET and the diode noise, also connecting serial diodes helps with reducing the diode current noise, in effect the noise from the JFET current at the output 7007A and the noise from RD at the output 5010A is reflected to the input by a factor

$$greater than {1 [ \frac{( C + {C}_{1} )}{C} ]}^{2}$$

for 1 pa leakage current we had

$$Is = 1 p A 20 {log}_{10} ( \frac{12.6 mv / \sqrt{2}}{0.46 uv} ) = 85 dB$$

it is possible to increase this term by 10 dB by adding C1=2C, this requires that G will compensate the

$${[ \frac{( C + {C}_{1} )}{C} ]}^{2}$$

so this requires that G=10, still having Rd=100 ohm, this requires gm=0.1, or Id=100 ma, this is possible when using JFET with IDSS=100 ma.

Distortion Analysis

The equation of a diode is given by:

$${I}_{D} = {I}_{0} ( {e}^{\frac{{V}_{D}}{( \frac{KT}{q} )}} - 1 ) = {I}_{0} ( ( \frac{{V}_{D}}{{V}_{T}} ) + \frac{1}{2 !} {( \frac{{V}_{D}}{{V}_{T}} )}^{2} + \frac{1}{3 !} {( \frac{{V}_{D}}{{V}_{T}} )}^{3} + \frac{1}{4 !} {( \frac{{V}_{D}}{{V}_{T}} )}^{4} … ) == {I}_{0} ( ( x ) + \frac{1}{2 !} {( x )}^{2} + \frac{1}{3 !} {( x )}^{3} + \frac{1}{4 !} {( x )}^{4} … ) where {V}_{T} = \frac{KT}{q} and x = \frac{{V}_{D}}{{V}_{T}} \qquad Eq . 22$$

It is clear that for 1 pa-10 pa the impedance of a diode is about 25 mV/(2*1 e−12)=12.5 GOhm, which means that all Von will be developed if we have C=10 pF 5002a at even low frequencies like 100 Hz, also it is known that the voltage on a microphone acoustic element is about its sensitivity which is about 12 mV this means that 12 mV/25 mc=x=0.5 will generate relatively high distortion, by adding several diodes the Vin voltage is divided over all diodes and hence by having for example p=25 we have x=0.5 mV/25 mV= 1/50, this means that the next that the distortion will come from

$$\frac{1}{2 !} {( \frac{{V}_{D}}{{V}_{T}} )}^{2} .$$

$$As \frac{1}{2 !} {( \frac{{V}_{D}}{{V}_{T}} )}^{2} = \frac{1}{2 !} {( \frac{{V}_{D} ( dc ) + Vin / P}{{V}_{T}} )}^{2} = \frac{1}{2 !} ( \frac{{V}_{D} ( dc )}{{V}_{T}} + 2 \frac{{V}_{D} ( dc )}{{V}_{T}} \frac{Vin}{P} + {( \frac{Vin / P}{{V}_{T}} )}^{2} ) ,$$

which shows that the distortion current is

$${I}_{0} \frac{1}{2 !} {( \frac{Vin / P}{{V}_{T}} )}^{2} .$$

Analysis of serial diodes network connection of FIG. 7 and FIG. 8.

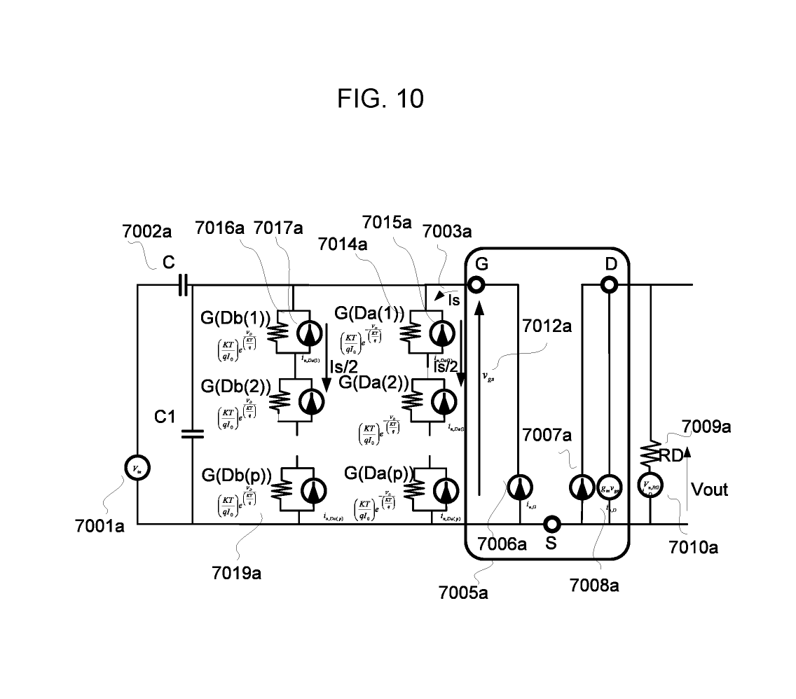

Reference is now made to FIG. 10, which is a simplified illustration of AC and noise equivalent circuit of FIG. 7, according to one exemplary embodiment.

In FIG. 7, a dual branch network of p diodes per each network is connected between the gate (input) and ground, the first network 7003 and a second network 7013, basically if Vgs=V, then each diode of the first network 7003 gets a voltage of V/p while each diode of the second network gets −V/p since V is very small, then the current flowing on the first network is equal to about

$${I}_{0} ( ( V / p ) + \frac{1}{2 !} {( V / p )}^{2} + \frac{1}{3 !} {( V / p )}^{3} + \frac{1}{4 !} {( V / p )}^{4} … )$$

and for the second network

$$7013 - {I}_{0} ( ( V / p ) - \frac{1}{2 !} {( V / p )}^{2} + \frac{1}{3 !} {( V / p )}^{3} - \frac{1}{4 !} {( V / p )}^{4} … )$$

with V/p is the voltage across Da(1), Da(2) . . . Da(p) the first diode branch 7015a and −V/p is the voltage across Db(1), Db(2) . . . Db(p) the second diode branch 7017a.

Part of the JFET leakage is 7003a will flow through the first branch 7015a and part will flow through the second branch 7017a.

The noise of each diode Da(1), Da(2) . . . Da(p) 7003 of FIG. 7 is given by:

i_{n,Da(k)}²=(2αIₛ+I₀)qΔf Eq. 23

where αIₛ is the current flowing into the first diode branch from the JFET leakage.

The reason for connecting diodes in series is to reduce the distortion. The input voltage V may be divided by P for each diode as well as reducing the noise resulted from the diode noise current. First we show that connecting diodes in series actually reduces the total diode noise.

One can transform the diodes of branch 7003 of the circuit of FIG. 7A using the Thevenin theorem and get the following total current with the following total resistance.

$${i}_{n , diodes} = \frac{\sqrt{{( 2 α {I}_{S} + {I}_{0} ) q Δ {f ( \frac{2 KT}{{qI}_{0}} {e}^{\frac{{V}_{D}}{( \frac{KT}{q} )}} )}^{2}}^{( 2 α {I}_{S} + {I}_{0} ) q Δ {f ( \frac{2 KT}{{qI}_{0}} {e}^{\frac{{V}_{D}}{( \frac{KT}{q} )}} )}^{2} + ( 2 α {I}_{S} + {I}_{0} ) q Δ {f ( \frac{2 KT}{{qI}_{0}} {e}^{\frac{{V}_{D}}{( \frac{KT}{q} )}} )}^{2} + … +}}}{p ( \frac{2 KT}{{qI}_{0}} {e}^{\frac{{V}_{D}}{( \frac{KT}{q} )}} )} == \frac{\sqrt{( 2 {αI}_{S} + {I}_{0} ) q Δ f}}{\sqrt{p}} \qquad Eq . 24$$

And the total resistance is

$$p ( \frac{2 KT}{{qI}_{0}} {e}^{\frac{{V}_{D}}{( \frac{KT}{q} )}} ) .$$

This does not gives any thermal noise it is just the slope of the diode current, having C1. The same is applies to the second diode network 7013.

The total current noise is the square sum of the first diode branch current noise the second diode branch current noise and the gate leakage noise 5014a and is given by:

$${i}_{n , diodes + jfet}^{2} = \frac{( 2 α {I}_{S} + {I}_{0} ) q Δ f}{p} + \frac{( 2 ( 1 - α ) {I}_{S} + {I}_{0} ) q Δ f}{p} + 2 {I}_{S} q Δ f == \frac{( 2 {I}_{S} + 2 {I}_{0} ) q Δ f}{p} + 2 {I}_{S} q Δ f \approx 2 {I}_{S} q Δ f for p \geq 10 \qquad Eq . 25$$

We can conclude that Eq. 15 now will take the form:

$${v}_{n , in}^{2} = \frac{{v}_{n , out}^{2}}{{G}^{2}} = \frac{1}{{G}^{2}} {{\int }_{{f}_{1}}}^{{f}_{2}} {\vert {v}_{n , out} ( f ) \vert}^{2} df = 2 {I}_{S} q ( \frac{1}{4 {{π}^{2} ( C + {C}_{1} )}^{2}} ) {ξ}_{1} + \frac{8}{3 G} {KTR}_{D} {{ξ}_{2} [ \frac{( C + {C}_{1} )}{C} ]}^{2} ++ {\frac{4 {KTR}_{D} {ξ}_{2}}{{G}^{2}} [ \frac{( C + {C}_{1} )}{C} ]}^{2} \qquad Eq . 26$$

One can see from equation 24, that C1 helps with reducing the current noise from the PN junction of the JFET and the diode noise, also connecting serial diodes helps with reducing the diode current noise, in effect the noise from the JFET current at the output 5007a and the noise from RD at the output 5010a is reflected to the input by a factor greater than

$${1 [ \frac{( C + {C}_{1} )}{C} ]}^{2}$$

for 1 pA leakage current we had

$$Is = 1 pA \to 20 {log}_{10} ( \frac{12.6 mv / \sqrt{2}}{0.46 uv} ) = 85 dB$$

it is possible to increase this term by 10 dB by adding C1=2C. This requires that G will compensate the

$${[ \frac{( C + {C}_{1} )}{C} ]}^{2}$$

so this requires that G=10. Still having Rd=100 ohm, this requires gm=0.1, or Id=100 mA, this is possible when using JFET with IDSS=100 mA.

Distortion Analysis

The equation of a diode is given by:

$${I}_{D} = {I}_{0} ( {e}^{\frac{{V}_{D}}{( \frac{KT}{q} )}} - 1 ) = {I}_{0} ( ( \frac{{V}_{D}}{{V}_{T}} ) + \frac{1}{2 !} {( \frac{{V}_{D}}{{V}_{T}} )}^{2} + \frac{1}{3 !} {( \frac{{V}_{D}}{{V}_{T}} )}^{3} + \frac{1}{4 !} {( \frac{{V}_{D}}{{V}_{T}} )}^{4} … ) = {I}_{0} ( ( x ) + \frac{1}{2 !} {( x )}^{2} + \frac{1}{3 !} {( x )}^{3} + \frac{1}{4 !} {( x )}^{4} … ) where {V}_{T} = \frac{KT}{q} and x = \frac{{V}_{D}}{{V}_{T}} \qquad Eq . 27$$

It is important to mention that at DC the first diode branch 7003 will force a positive voltage across the diode branch, this will appear to the second diode branch 7013 as negative voltage, to find this voltage one can write.

$${I}_{s} = {I}_{0} ( {e}^{\frac{{V}_{D}}{( \frac{KT}{q} )}} - 1 ) - {I}_{0} ( {e}^{\frac{{V}_{D}}{( \frac{KT}{q} )}} - 1 ) \qquad Eq . 28$$

Mark

$$x = {e}^{\frac{{V}_{D}}{( \frac{KT}{q} )}} solves \frac{{I}_{s}}{{I}_{0}} = x - 1 - \frac{1}{x} + 1 if \frac{{I}_{s}}{{I}_{0}} = 1 ,$$

meaning diode may have leakage in the same order as JFET. This may result at 25 degrees with x=1.618 and V_{D}=12 mv.

As each diode in the first branch 7003 may get V/p, and on the second branch 7013 may get −V/p.

Then the diode on the first branch 7003 may have 12 mV+V/p and on the second branch −12 mV−V/p

The difference between the currents of branches 7003, 7013 is therefore:

$${I}_{on\_diode \_branches \_ 7003 \_ 7013} = {I}_{0} ( ( x ) + \frac{1}{2 !} {( x )}^{2} + \frac{1}{3 !} {( x )}^{3} + \frac{1}{4 !} {( x )}^{4} … ) - - {I}_{0} ( ( - x ) + \frac{1}{2 !} {( x )}^{2} + \frac{1}{3 !} {( - x )}^{3} + \frac{1}{4 !} {( x )}^{4} … ) \\ where {V}_{T} = \frac{KT}{q} and x = \frac{V / p + 12 mv}{{V}_{T}} = 2 {I}_{0} ( ( x ) + \frac{1}{3 !} {( x )}^{3} … ) = 2 {I}_{0} ( ( \frac{V / p}{{V}_{T}} ) + \frac{1}{3 !} {( \frac{12 mv}{{V}_{T}} )}^{3} ( 1 + 3 {( \frac{V / p}{12 mv} )}^{2} + 3 ( \frac{V / p}{12 mv} ) + {( \frac{V / p}{12 mv} )}^{3} ) … ) \qquad Eq . 29$$

If we have C=10 pF 7002a at even lower frequencies such as 100 Hz, it is clear that for 1 pA-10 pA the impedance of a diode is about 25 mV/(2*1 e−12)=12.5 GOhm, which means that all Vin will be developed on the input.

The distortion voltage at the input may come from the voltage drop on C and from the distortion elements described by Eq. 27. For Very small V/p (Assuming microphone acoustic element is about its sensitivity which is about 12 mv this means that 12 mv/10=1.2 mv).

The term

$$3 {( \frac{V / p}{12 mv} )}^{2} \frac{1}{3 !} {( \frac{12 mv}{{V}_{T}} )}^{3} = 2 {I}_{0} \frac{1}{2} {( \frac{V / p}{1} )}^{2} ( \frac{12 mv}{{V}_{T}} ) \approx {{I}_{S} ( \frac{V / p}{1} )}^{2} ( \frac{12 mv}{{V}_{T}} )$$

generates the distortion.

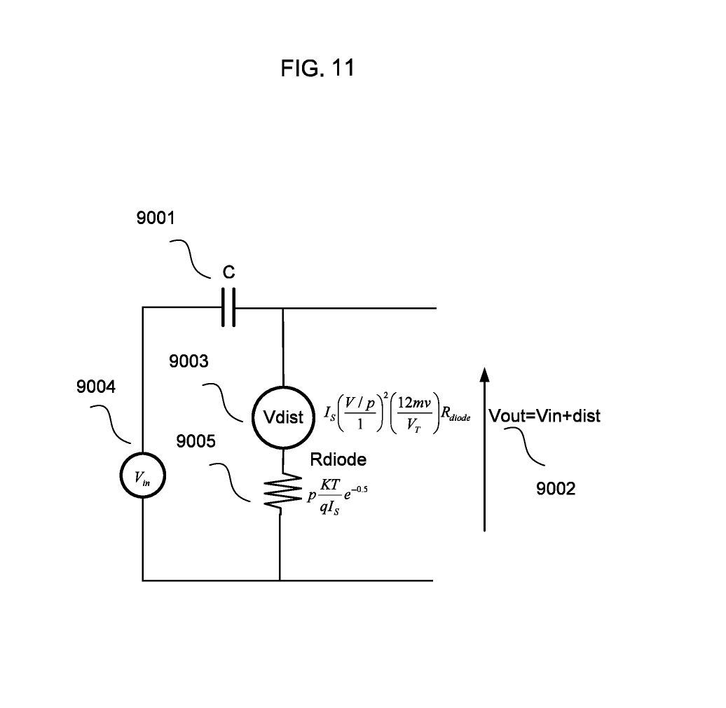

FIG. 11 is a simplified electric schematic illustrating the distortion due to the diodes network, according to one exemplary embodiment.

One can show that the distortion is given by:

$${{I}_{S} ( \frac{{V}_{in} / p}{1} )}^{2} ( \frac{12 mv}{{V}_{T}} ) ( \frac{1}{jwc} ) \qquad Eq . 30$$

and therefore in dB we have

$$Distotion [ dB ] = 20 log 10 [ \frac{{{I}_{S} ( \frac{{V}_{in} / p}{1} )}^{2} ( \frac{12 mv}{{V}_{T}} ) ( \frac{1}{wc} )}{{V}_{in}} ] \qquad Eq . 31$$

Eq. 31 shows that putting series of diodes will decrease the distortion.

For 2 pA current and 10 pF and p=1 and Vin=12 mV, f=100 (at sensitivity level) we have distortion of 23 nV, which may be acceptable for audio applications.

Distortion Source

For a low Is leakage of 1 pA-10 pA, with one diode, the impedance of the diode will be 2500 Mohm-25 Gohm (with 10 pA) at 100 Hz and 10 pF for C 7002a. Impedance of 100 MOhm may give a voltage of 1/25 from the input, and for one diode this may mean that for maximal sensitivity the distortion would be 1/25*⅛. This is a high value with a p diodes in series and parallel branches 7003 and 7013. We therefore have for maximal sensitivity—assuming p=10 − 1/25*⅙*(1.2/25)·̂3=1/1.3M, which reflects distortion of more than 120 dB (calculated using Eq. 31).

Reason for Series of Diodes

There are two reasons for arranging diodes in series in each branch 7003 and 7013. The first reason is based on equation 22. This connection reduces the current noise from the diode current noise. The second reason is to divide the voltage across each diode such that the term (V/p)/25 mv will be small enough.

Reason for Parallel Branches

Parallel branches eliminate the even distortion components as shown by Eq. 26.

Ultra-Low-Power Low Noise Microphone Circuit

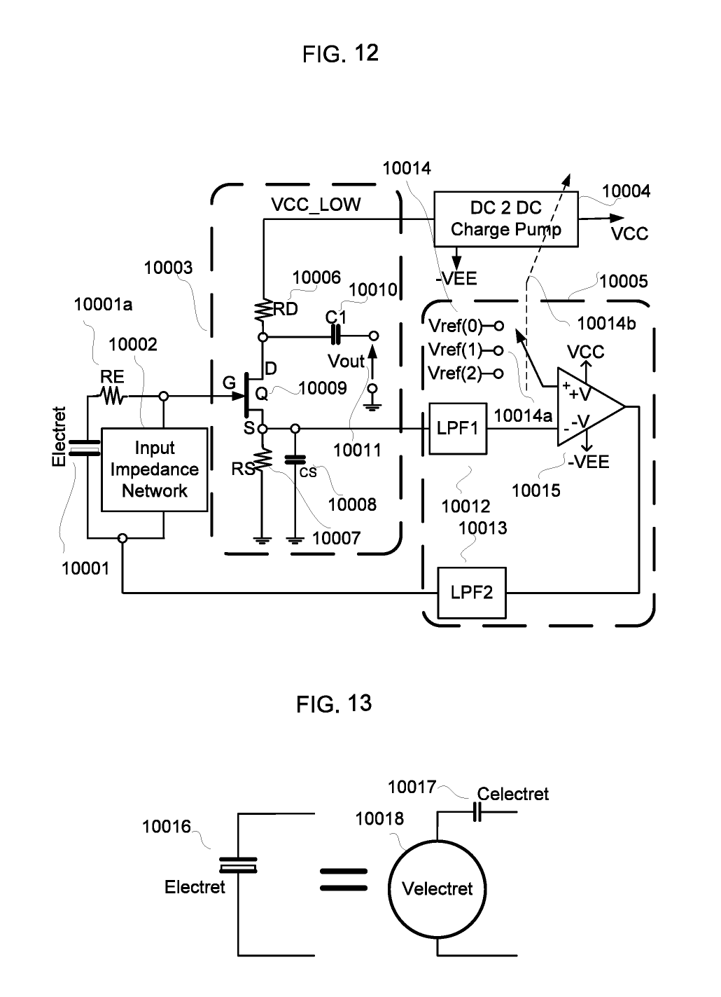

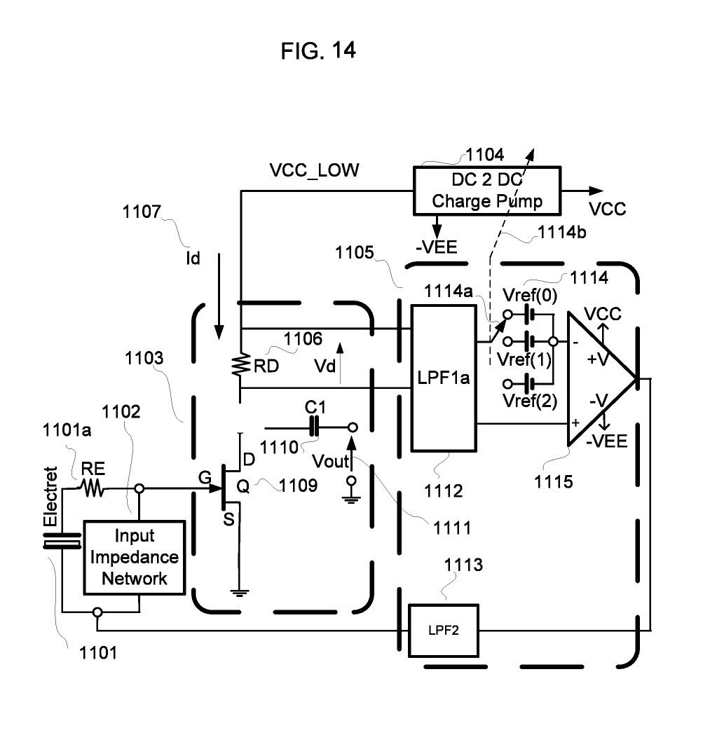

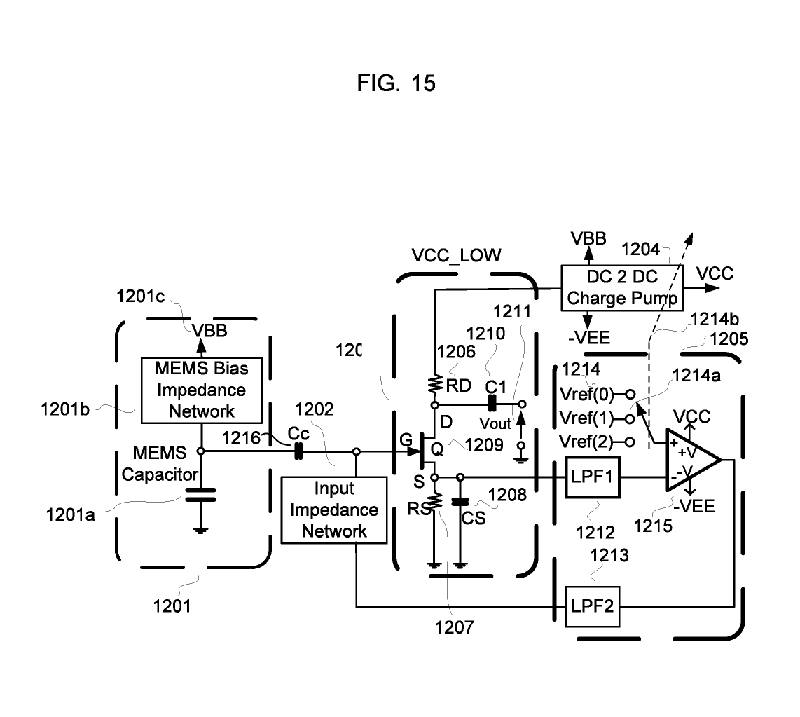

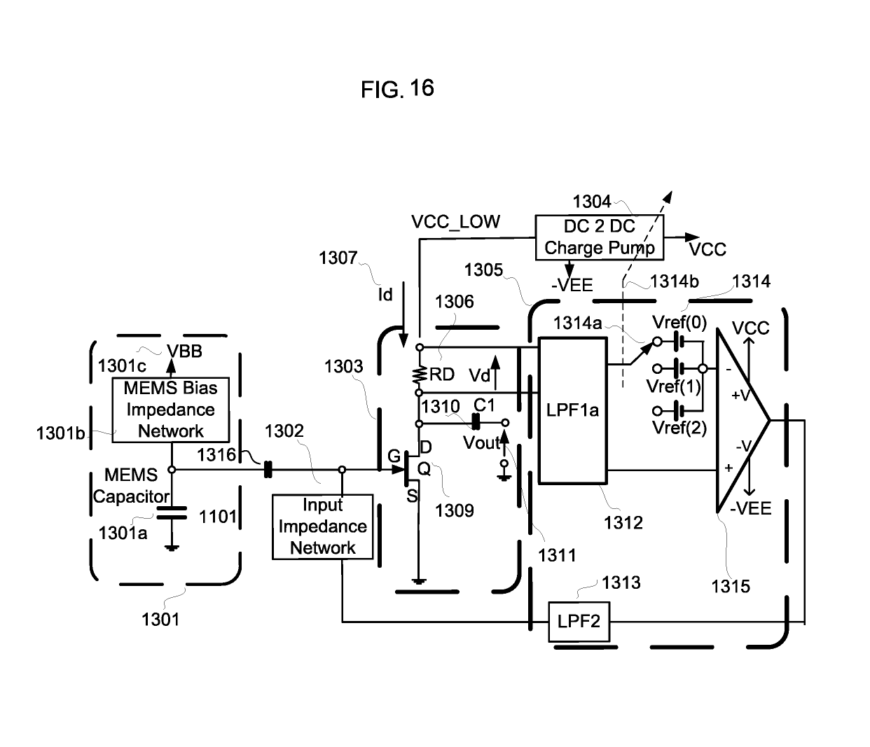

FIG. 12, FIG. 14, FIG. 15 and FIG. 16 describe an ultra-low-noise and ultra-low-power microphone circuits.

FIG. 12 is a simplified electric schematic of an Electret Condenser Microphone (ECM) ultra-low-noise ultra-low-power microphone with feedback from source, according to one exemplary embodiment.

FIG. 13 is a simplified electric schematic of an equivalent circuit of the ECM, according to one exemplary embodiment.

FIG. 14 is a simplified electric schematic of an Electret Condenser Microphone (ECM) ultra-low-noise ultra-low-power microphone with feedback from drain, according to one exemplary embodiment.

FIG. 15 is a simplified electric schematic of a Micro Electrical Mechanical System Microphone ultra-low-noise ultra-low-power microphone with feedback from source, according to one exemplary embodiment.

FIG. 16 is a simplified electric schematic of a Micro Electrical Mechanical System Microphone ultra-low-noise ultra-low-power microphone with feedback from drain, according to one exemplary embodiment.

FIG. 12 describes an ultra-low-power ultra-low-noise microphone, where the low noise part is achieved by using a diode based input impedance 1002, which was described by FIG. 5, FIG. 6, FIG. 7 and FIG. 8. The input impedance may include a parallel capacitor C1 described as 5011, 6011, 7011 and 8011 in FIG. 5, FIG. 6, FIG. 7 and FIG. 8 respectively.

A wide JFET transistor, in which the IDSS current is large, is used to get the low power performance. Eq. 32 describes the relation between V_{GS} and I_{D} of the JFET 10009, of FIG. 10

$${I}_{D} = {{I}_{DSS} ( 1 - \frac{{V}_{GS}}{{V}_{P}} )}^{2} {g}_{m} = - \frac{2}{{V}_{P}} \sqrt{{I}_{D} {I}_{DSS}} \qquad Eq . 32$$

Recall from equation 26 given here as

$${v}_{n , in}^{2} = \frac{{v}_{n , out}^{2}}{{G}^{2}} = \frac{1}{{G}^{2}} {{\int }_{{f}_{1}}}^{{f}_{2}} {\vert {v}_{n , out} ( f ) \vert}^{2} df == 2 {I}_{S} q ( \frac{1}{4 {{π}^{2} ( C + {C}_{1} )}^{2}} ) {ξ}_{1} + \frac{8}{3 G} {KTR}_{D} {{ξ}_{2} [ \frac{( C + {C}_{1} )}{C} ]}^{2} ++ {\frac{4 {KTR}_{D} {ξ}_{2}}{{G}^{2}} [ \frac{( C + {C}_{1} )}{C} ]}^{2} \qquad Eq . 33$$

The reflected noise at the input may include three elements:

A first noise element is

$$2 {I}_{S} q ( \frac{1}{4 {{π}^{2} ( C + {C}_{1} )}^{2}} ) {ξ}_{1}$$

originating from the PN junction of the JFET 10009 combined with the current noise of the input impedance leakage current diodes 10002, the second:

$$\frac{8}{3 G} {KTR}_{D} {{ξ}_{2} [ \frac{( C + {C}_{1} )}{C} ]}^{2}$$

comes from the JFET 10009 current noise between drain (D) to source (S), the third

$$\frac{4 {KTR}_{D} {ξ}_{2}}{{G}^{2}} [ \frac{( C + {C}_{1} )}{C} ]$$

comes from the load resistor 10006 (RD).

The first element may be decreased using C1 5011, 6011, 7011 and 8011 in the input impedance and also may be reduced by using JFET with ultra-low-leakage is, the second and third are decreased when G, the gain is increased, for JFET 10009 in the saturation region we have:

G=gₘR_{D} Eq. 32

Therefore, the second and third elements of noise may be described by Eqs. 34 and 35 as follows:

$$\begin{matrix}\frac{8}{3 G} {KTR}_{D} {{ξ}_{2} [ \frac{( C + {C}_{1} )}{C} ]}^{2} = \frac{8}{3 {g}_{m}} KT {{ξ}_{2} [ \frac{( C + {C}_{1} )}{C} ]}^{2} & Eq . 34 \\ {\frac{4 {KTR}_{D} {ξ}_{2}}{{G}^{2}} [ \frac{( C + {C}_{1} )}{C} ]}^{2} = {\frac{4 KT}{{g}_{m}^{2} {R}_{D}} [ \frac{( C + {C}_{1} )}{C} ]}^{2} & Eq . 35\end{matrix}$$

One can see from Eq. 34 and Eq. 35 that the second and third reflected input noise depend on gm, so we might want to have a large gm, one can use a wide JFET 10009, such that IDSS is extremely high, such that in order to get some gm,

$$\frac{2}{{V}_{P}} \sqrt{{I}_{D} {I}_{DSS}}$$

we will need to use low Id. For example with prior art microphones a JFET transistor with Vp=1 v and IDSS=0.5 mA with VGS=0 is normally used, one can use a IDSS=150 ma to 300 mA JFET with low-leakage such as MX-16 of MOXTEK with VP=−8V, with such transistor in order to get the same prior art gm we need a Id=500 ua/300=1.7 μA, in order to have the JFET in saturation region we need V_{DS}≥V_{Gs}−V_{P} with such Id we have:

$${V}_{GS} - {V}_{P} = \vert {V}_{P} \vert \sqrt{\frac{{I}_{D}}{{I}_{DSS}}} = \frac{\vert {V}_{P} \vert}{300} = \frac{8}{300} = 27 mv \qquad Eq . 35$$

with 1.7 ua, we also assume about 20 mV for RS 1007 and RD 1006 (10 mV each) this may mean 92 nWatts of power consumption.

The circuit of FIG. 10 includes a DC to DC—switched capacitors voltage converter (charge pump) 1004 that gets a supply voltage VCC and generates VCC_LOW which is the voltage that drives the microphone buffer 10003, this voltage as suggested is about 20 mv-50 mv, with low total power consumption.

Voltage buffer 10003, may include an active element JFET 10009—that may be also implemented using Metal Oxide Semiconductor FET (MOSFET), the buffer 1003 includes a load resistor RD 10005 which is used for amplification, Vout 1011 is taken via coupling capacitor C1 10010.

To set the required Id—that insures with the VCC_LOW that JFET 1009 is in saturation mode, a current control block 1005 is added. This current control block may include an ultra-low-power comparator 1015 and two Low Pass Filters 1012 and 1013. The filters are needed to block the noise coming from the ultra-low-power comparator, which works with a few Nano ampere, may have to work in a very low gain bandwidth.

High noise at the comparator input (a few micro volts) may result in high noise at the comparator output. LPF1 is a bi-directional low pass filter that may block the noise coming from the “-” input of the ultra-low-power comparator 1015. LPF1 may also get a sampled voltage from the RS 1007, which transform the Id into Id*RS. This voltage is compared with Vref 10014. Here we describe 3 switchable Vref, using switch 1014a, for different Vref value. We may also change VCC_LOW. This may be done by 10014b. When the feedback is stable Vref=Id*RS and hence Id=Vref/RS. If Id*Rd>Vref the comparator may generate a negative voltage that is supplied to the gate of the JFET 1009 through LPF2 and the input impedance network 1002. This negative voltage may decrease the current.

The input impedance network 10002 may include a diodes network as described by FIG. 5 5003, FIG. 6 6003, FIG. 7 7003 or FIG. 8 8003. As a very low current Is 5015, 6015, 7015 and 8015 is flowing through the diode network, and the leakage Is 5015, 6015, 7015 and 8015 is the same order of the diode leakage, this may mean that each diode may have about KT/q voltage or about 25 mV during DC.

In order to have high gain, a bypass capacitor CS 1008 is added in parallel to RS 10007.

The charge pump 10004 supplies two voltages VCC_LOW to drive the microphone buffer 10003. This VCC_LOW can be further control by the Vref switch 10014a via 10014b. The charge pump 10004 also supplies −VEE for the ultra-low-power comparator 10015. The electret element 10001, which is a capacitor with a polarized element, may have high voltage on its pins. This voltage is discharged using the diode networks. An optional low resistor (100 ohm) RE 1001a may be added to allow a controlled discharge of the electrets element 1001 during manufacturing. This may limit the discharge current such that the diodes in the diode network 1002 may not be harmed. A parallel capacitor to the input impedance 10002 C1, such as 5011, 6011, 7011 and 8011 may be added in the input impedance. This C1 allows reduction of the noise due to the leakage current from the gate of the JFET 10009.

FIG. 13 is a simplified illustration of a model of the electrets 10016, which may be thought as Celectet 10017 in series to Velectert 108, according to one exemplary embodiment.

Reference is now made to FIG. 14, which is an improved version of the ultra-low-power ultra-low-noise microphone of FIG. 12. The circuit of FIG. 14 is similar to the circuit of FIG. 12 except for the feedback part. In the circuit of FIG. 14 there is no need for RS 10007 resistor and CS 10008 capacitor. Instead the current to voltage is taken from RD the load resistor 1106, through LPF1a 1112. The purpose of LPF1a is to pass the voltage Id*RD to the comparator. Then, −Vref 1114, with the selected Vref switch 1114a is added giving a voltage of Id*RD−Vref between the “−” and “+” terminals of the comparator 1115. If of Id*RD−Vref<0 a positive voltage is created at the output of the comparator 1115, which increases the current Id 1107. The selection of Vref switch 114a, may also control the VCC_LOW via 1114b.

The advantage of the circuit of FIG. 14 is the reduction of the VCC_LOW by about the voltage on RS 1007. This may decrease the VCC_LOW and hence may create a microphone buffer 1103 with a lower power consumption.

FIG. 15 describes a microphone buffer similar to the circuit of FIG. 12, however using a Micro Electronic Mechanical System (MEMS) microphone. The circuit is similar to the one of FIG. 12 except for the electret element 1001. The electret element 10001 is replaced by a MEMS unit 1201.

The microphone buffer similar of FIG. 15 may also include a MEMS bias impedance network 1201b and a MEMS capacitor 1201a, which may translate the acoustic wave pressure into variation in capacitance. These variations, with the assumption of constant charge on the MEMS capacitor, may be translated into voltage variations since:

$${V}_{BB} {C}_{electret} = ( {V}_{BB} + Δ V ) ( {C}_{electret} + Δ C ) Δ V = - {V}_{BB} \frac{Δ C}{{C}_{electret}}$$

The voltage variations may be coupled to the microphone buffer 1203 through Cc c-coupling capacitor 1216.

VBB is the bias voltage for the MEMS capacitor. This voltage may be positive or negative, and is generated using the switch capacitor charge pump 1204. To generate “clean” VBB it may be required to generate a higher voltage to pass it through a Low Pass Filter and a buffer. This may be implemented using an op amplifier. The op amplifier output is further filtered with high resistors and capacitors.

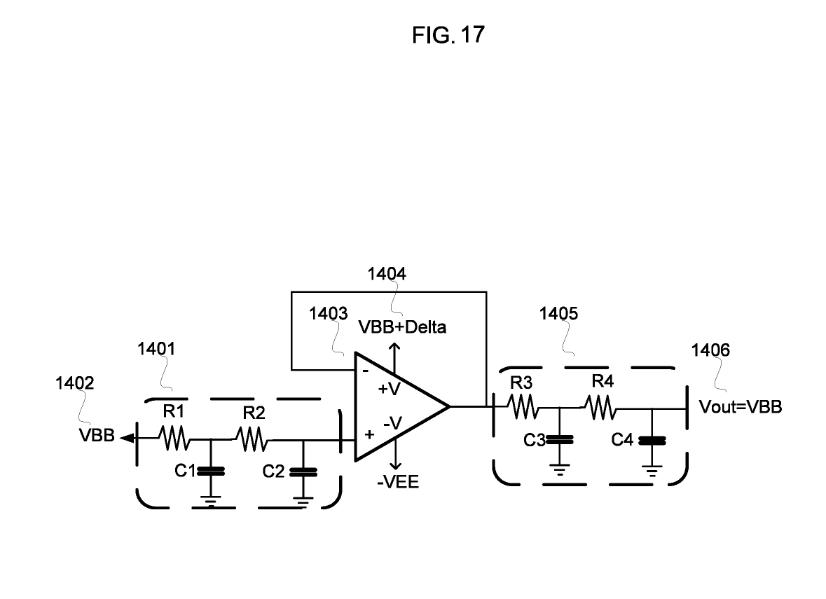

FIG. 17 is a simplified illustration of a low-noise VBB biasing circuit, according to one exemplary embodiment.

The low-noise VBB biasing of FIG. 17 may first block the noise from the VBB 1402 using LPF 1401, and may then pass the voltage using a unity gain amplifier 1403. The output of this amplifier, which is assumed to be low power, may have some noise that may be further blocked by a second LPF 1405. The cleaned VBB is at the output 1406, according to one exemplary embodiment.

The MEMS bias impedance network 1201b is a diode network as described in FIG. 5, FIG. 6, FIG. 7 and FIGS. 8 5013, 6013, 7013, and 8013

Improving Feedback Speed

In some case, switching between standby (where power consumption is low) to the payload state (where power consumption is high) may be done quickly. The feedback system described in FIG. 10, FIG. 11 FIG. 12 and FIG. 13 in blocks 10005, 1105, 1205, and 1305 are slow to mitigate this the feedback block 10005, 1105, 1205, and 1305.

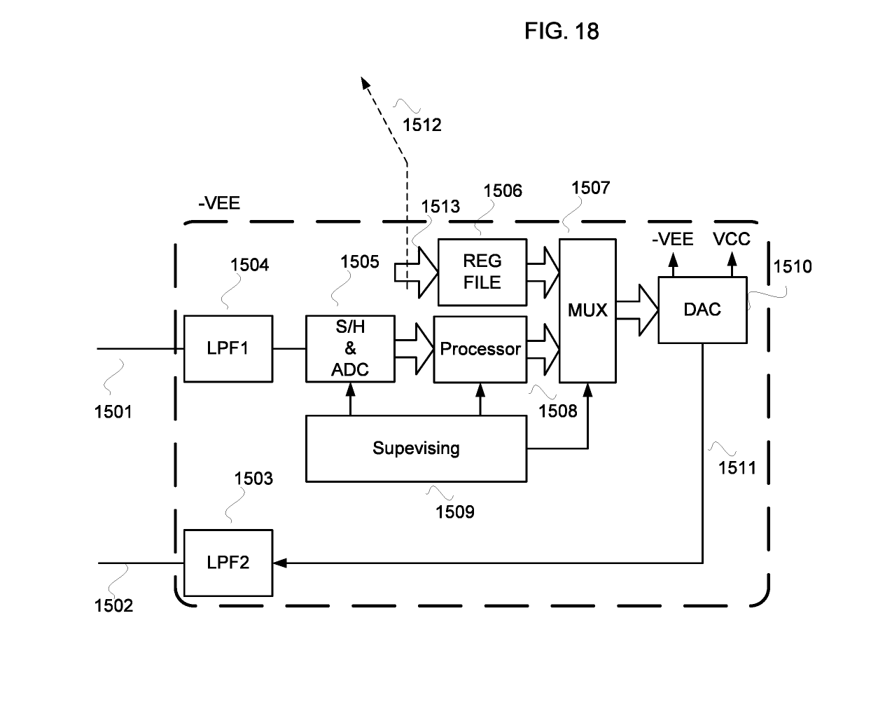

FIG. 18 is a simplified block diagram of a fast biasing circuit, according to one exemplary embodiment.

To provide fast feedback control on the bias of the JFET/MOSFET, a forward bias voltage generation may be used. FIG. 18 describes such method for the ultra-low-power ultra-low-noise microphone for acoustic communication. The block diagram described by FIG. 15 is used to replace 10005 of FIG. 12, or suitable feedback blocks in FIG. 14, FIG. 15 and FIG. 16.

The circuit described by FIG. 18 may be used to replace the feedback circuit 10005 of FIG. 12 and similar circuits in FIG. 14, FIG. 15 and FIG. 16. The circuit has one input 1501, taken from the resistor that transforms the current to voltage RS 10007 of FIG. 12, RD 1106 of FIG. 14, RS 1207 of FIG. 15 and RD 1306 of FIG. 16. The circuit has one output connected to the input biasing network 10002, 1102, 1202 and 1302. This node generates the required Vgs to set the JFET/MOSFET to the right working point.

The circuit of FIG. 18 may include LPF, LPF1 and LPF2 to block the noise from this forward biasing circuit. The circuit may also sample the current using the Sample and Hold (S/H) and converts this to digital number using the Analog to Digital Converter (ADC) 1505. The circuit may also include a processor 1508 that forces several VGS using the MUX 1507 and the Digital to analog converter (DAC) 1510, which may generate from VCC to −VEE. The circuit may also perform measurements of the ID for several VGS. This operation may be controlled by a supervising circuit 1509 may keep the processor and its peripherals at standby. Hence operating at ultra-low-power consumption. The operation may repeated every a few minutes or seconds. Performing this operation the processor may determine what the VGS should be to get a desired Id.

While the supervising circuit 1509 sets the processor 1508 and its peripherals 1505 in standby, the MUX will transfer the required digital word for the VGS using the REG ILE 1506. This word may be transferred to the DAC 1510. In parallel, a suitable control for the charge pump is performed using 1512.

We claim:

1. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a switch comprising one pole and at least two throws, wherein each throw is connected to a different Vref voltage;
the op-amplifier comprising:
a first input terminal connected to the source terminal of the transistor through a bi-directional low pass filter;
a second input terminal connected to the pole of the switch;
a first power supply terminal connected to the inverted voltage;
a second supply terminal connected to main supply voltage; and
an output terminal connected to a second terminal of the input impedance network through a second low pass filter; and
an input electrets capacitor source connected in parallel to the input impedance network.

2. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low voltage power supply VCC_LOW connected to a second terminal of the load resistor;
an inverted voltage −VEE connected to a first power supply node of an op amplifier; and
a MEMS bias voltage VBB;
a switch comprising one pole and at least two throws, wherein each throw is connected to a different Vref voltage;
the op-amplifier comprising:
a first input terminal connected to the source terminal of the transistor through a bi-directional low pass filter;
a second input terminal connected to the pole of the switch;
a first power supply terminal connected to the inverted voltage;
a second supply terminal connected to main supply voltage; and
an output terminal connected to a second terminal of the input impedance network through a second low pass filter; and
an input source comprising:
a MEMS capacitor comprising a first terminal connected to ground, and a second terminal connected to a first terminal of a MEMS bias network;
a MEMS bias network comprising a second terminal connected to a bias voltage (VBB); and
a coupling capacitor comprising a first terminal connected to a second terminal of the MEMS capacitor, a second terminal connected to the gate terminal of the transistor.

3. A microphone comprising:
a transistor comprising at least one of a JFET transistor and a MOSFET transistor;
an input-impedance-network comprising a first terminal connected to a gate terminal of the transistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a switch comprising one pole and at least two throws, wherein each throw is connected to a different Vref voltage;
the op-amplifier comprising:
a first input terminal connected to a second (voltage) terminal of the RD resistor through a bi-directional low pass filter;
a second input terminal connected to the pole of the switch;
a first power supply terminal connected to the inverted voltage;
a second supply terminal connected to main supply voltage; and
an output terminal connected to a second terminal of the input impedance network through a second low pass filter; and
an input electrets capacitor source connected in parallel to the input impedance network.

4. A microphone comprising:
a transistor comprising at least one of a JFET transistor and a MOSFET transistor;
an input-impedance-network comprising a first terminal connected to a gate terminal of the transistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a switch comprising one pole and at least two throws, wherein each throw is connected to a different Vref voltage;
the op-amplifier comprising:
a first input terminal connected to a second (voltage) terminal of the RD resistor through a bi-directional low pass filter;
a second input terminal connected to the pole of the switch;
a first power supply terminal connected to the inverted voltage;
a second supply terminal connected to main supply voltage; and
an output terminal connected to a second terminal of the input impedance network through a second low pass filter; and
an input source comprising:
a MEMS capacitor comprising a first terminal connected to ground, and a second terminal connected to a first terminal of a MEMS bias network;
a MEMS bias network comprising a second terminal connected to a bias voltage (VBB); and
a coupling capacitor comprising a first terminal connected to a second terminal of the MEMS capacitor, a second terminal connected to the gate terminal of the transistor.

5. The microphone according to any of claims 1, 2, 3, and 4, wherein the input impedance network comprises:
a plurality of low-leakage diodes connected in series wherein
a cathode terminal of a first diode of the plurality of low-leakage diodes is the first terminal of the input impedance network;
an anode terminal of the first diode is connected to a cathode terminal of a second diode of the plurality of low-leakage diodes; and
an anode terminal of a last diode of the plurality of low-leakage diodes connected in series is the second terminal to the input impedance network.

6. The microphone according to any of claims 1, 2, 3, and 4, wherein the input impedance network comprises:
a plurality of low-leakage diodes connected in series wherein
an anode terminal of a first diode of the plurality of low-leakage diodes is the first terminal of the input impedance network;
a cathode terminal of the first diode is connected to a cathode terminal of a second diode of the plurality of low-leakage diodes; and
a cathode terminal of a last diode of the plurality of low-leakage diodes connected in series is the second terminal to the input impedance network.

7. The microphone according to any of claims 1, 2, 3, and 4, wherein the input impedance network comprises:
a first plurality of diodes connected in series wherein
a cathode terminal of a first diode of the first plurality of diodes is the first terminal of the input impedance network;
an anode terminal of the first diode is connected to a cathode terminal of a second diode of the first plurality of diodes; and
an anode terminal of a last diode of the first plurality of diodes is the second terminal to the input impedance network; and
a second plurality of diodes connected in series wherein
an anode terminal of a first diode of the second plurality of diodes is connected to the first terminal of the input impedance network;
a cathode terminal of the first diode is connected to a cathode terminal of a second diode of the second plurality of diodes; and
a cathode terminal of a last diode of the second plurality of diodes is connected to the second terminal to the input impedance network.

8. The microphone according to any of claims 2 and 4, wherein the input impedance network comprises at least two two-terminal sub-networks connected in series wherein
a first terminal of a first sub-network is the first terminal of the input impedance network;
a second terminal of a last sub-network is the second terminal of the input impedance network; and
a sub-network comprises two identical low-leakage diodes connected in parallel and in opposite polarity.

9. The microphone according to any of claims 2 and 4, wherein the MEMS bias network comprises:
a plurality of low-leakage diodes connected in series wherein
a cathode terminal of a first diode of the plurality of low-leakage diodes is the first terminal of the MEMS bias network;
an anode terminal of the first diode is connected to a cathode terminal of a second diode of the plurality of low-leakage diodes; and
an anode terminal of a last diode of the plurality of low-leakage diodes connected in series is the second terminal to the MEMS bias network.

10. The microphone according to any of claims 2 and 4, wherein the MEMS bias network comprises:
a plurality of low-leakage diodes connected in series wherein
an anode terminal of a first diode of the plurality of low-leakage diodes is the first terminal of the MEMS bias network;
a cathode terminal of the first diode is connected to a cathode terminal of a second diode of the plurality of low-leakage diodes; and
a cathode terminal of a last diode of the plurality of low-leakage diodes connected in series is the second terminal to the MEMS bias network.

11. The microphone according to any of claims 2 and 4, wherein the MEMS bias network comprises:
a first plurality of diodes connected in series wherein
a cathode terminal of a first diode of the first plurality of diodes is the first terminal of the MEMS bias network;
an anode terminal of the first diode is connected to a cathode terminal of a second diode of the first plurality of diodes; and
an anode terminal of a last diode of the first plurality of diodes is the second terminal to the MEMS bias network; and
a second plurality of diodes connected in series wherein
an anode terminal of a first diode of the second plurality of diodes is connected to the first terminal of the MEMS bias network;
a cathode terminal of the first diode is connected to a cathode terminal of a second diode of the second plurality of diodes; and
a cathode terminal of a last diode of the second plurality of diodes is connected to the second terminal to the MEMS bias network.

12. The microphone according to any of claims 2 and 4, wherein the MEMS bias network comprises at least two two-terminal sub-networks connected in series wherein
a first terminal of a first sub-network is the first terminal of the MEMS bias network;
a second terminal of a last sub-network is the second terminal of the MEMS bias network; and
a sub-network comprises two identical low-leakage diodes connected in parallel and in opposite polarity.

13. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a feed-forward bias-voltage-supply circuit comprising:
a first input connected to the first terminal of the source resistor;
a second input, wherein bias is determined;
a third input connected to main power supply;
a fourth input connected to the inverted voltage; and
a first output connected to a second terminal of the input impedance network; and
an input electrets capacitor source connected in parallel to the input impedance network.

14. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low voltage power supply VCC_LOW connected to a second terminal of the load resistor;
an inverted voltage −VEE connected to a first power supply node of an op amplifier; and
a MEMS bias voltage VBB;
a feed forward bias voltage comprising:
a first input connected to the first terminal of the source resistor;
a second input, wherein bias is determined;
a third input connected to main power supply;
a fourth input connected to the inverted power supply; and
a first output connected to a second terminal of the input impedance network; and
an input source comprising:
a MEMS capacitor comprising a first terminal connected to ground, and a second terminal connected to a first terminal of a MEMS bias network;
a MEMS bias network comprising a second terminal connected to a bias voltage (VBB); and
a coupling capacitor comprising a first terminal connected to a second terminal of the MEMS capacitor, a second terminal connected to the gate terminal of the transistor.

15. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a feed-forward bias-voltage-supply circuit comprising:
a first input connected to the first (voltage) terminal of the load resistor (RD),
a second input wherein bias is determined;
a third input connected to the power supply;
a fourth input connected to the inverted voltage;
a first output connected to a second terminal of the input impedance network; and
an input electrets capacitor source connected in parallel to the input impedance network.

16. A microphone comprising:
a transistor comprising at least one of a JFET transistor and a MOSFET transistor;
an input-impedance-network comprising a first terminal connected to a gate terminal of the transistor;
a source resistor comprising a first terminal connected to a source terminal of the transistor, and a second terminal connected to a ground terminal;
a bypass capacitor (CS) connected in parallel to the source resistor;
a load resistor (RD) comprising a first terminal connected to a drain terminal of the transistor;
a charge-pump generating:
a low-voltage (VCC_LOW) connected to a second terminal of the load resistor; and
an inverted voltage (−VEE) connected to a first power supply node of an op amplifier;
a feed-forward bias-voltage-supply circuit comprising:
a first input connected to the first (voltage) terminal of the load resistor (RD),
a second input wherein bias is determined;
a third input connected to the power supply;
a fourth input connected to the inverted voltage;
a first output connected to a second terminal of the input impedance network; and
an input source comprising:
a MEMS capacitor comprising a first terminal connected to ground, and a second terminal connected to a first terminal of a MEMS bias network;
a MEMS bias network comprising a second terminal connected to a bias voltage (VBB); and
a coupling capacitor comprising a first terminal connected to a second terminal of the MEMS capacitor, a second terminal connected to the gate terminal of the transistor.

17. The microphone according to any of claims 13, 14, 15, and 16, additionally comprising a second terminal of the feed-forward bias-voltage-supply circuit connected to the charge pump.

18. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier;
connecting a switch comprising one pole and at least two throws, wherein each throw is connected to a different Vref voltage;
connecting a first input terminal the op-amplifier to the source terminal of the transistor through a bi-directional low pass filter;
connecting a second input terminal of the op-amplifier to the pole of the switch;
connecting a first power supply terminal of the op-amplifier to the inverted voltage;
connecting a second power supply terminal of the op-amplifier to main supply voltage;
connecting an output terminal of the op-amplifier to a second terminal of the input impedance network through a second low pass filter; and
connecting an input electrets capacitor source in parallel to the input impedance network.

19. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier;
connecting a switch comprising one pole and at least two throws, wherein each throw is connected to a different Vref voltage;
connecting a first input terminal the op-amplifier to the source terminal of the transistor through a bi-directional low pass filter;
connecting a second input terminal of the op-amplifier to the pole of the switch;
connecting a first power supply terminal of the op-amplifier to the inverted voltage;
connecting a second power supply terminal of the op-amplifier to main supply voltage;
connecting an output terminal of the op-amplifier to a second terminal of the input impedance network through a second low pass filter;
connecting a first terminal of a MEMS capacitor to ground;
connecting a second terminal of the MEMS capacitor to a first terminal of a MEMS bias network;
connecting a second terminal of the MEMS bias network to a bias voltage (VBB) generated by the charge-pump;
connecting a first terminal of a coupling capacitor to a second terminal of the MEMS capacitor; and
connecting a second terminal of the coupling capacitor to the gate terminal of the transistor.

20. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier;
connecting a switch comprising one pole and at least two throws, wherein each throw is connected to a different Vref voltage;
connecting a first input terminal of the op amplifier to a second (voltage) terminal of the RD resistor through a bi-directional low pass filter;
connecting a second input terminal of the op amplifier to the pole of the switch;
connecting a first power supply terminal of the op amplifier to the inverted voltage;
connecting a second supply terminal of the op amplifier to main supply voltage;
connecting an output terminal of the op amplifier to a second terminal of the input impedance network through a second low pass filter; and
connecting an input electrets capacitor source in parallel to the input impedance network.

21. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier;
connecting a switch comprising one pole and at least two throws, wherein each throw is connected to a different Vref voltage;
connecting a first input terminal of the op amplifier to a second (voltage) terminal of the RD resistor through a bi-directional low pass filter;
connecting a second input terminal of the op amplifier to the pole of the switch;
connecting a first power supply terminal of the op amplifier to the inverted voltage;
connecting a second supply terminal of the op amplifier to main supply voltage;
connecting an output terminal of the op amplifier to a second terminal of the input impedance network through a second low pass filter;
connecting a first terminal of a MEMS capacitor to ground;
connecting a second terminal of the MEMS capacitor to a first terminal of a MEMS bias network;
connecting a second terminal of the MEMS bias network to a bias voltage (VBB) generated by the charge-pump;
connecting a first terminal of a coupling capacitor to a second terminal of the MEMS capacitor; and
connecting a second terminal of the coupling capacitor to the gate terminal of the transistor.

22. The method according to any of claims 18, 19, 20, and 21, additionally comprising:
connecting a plurality of low-leakage diodes in series wherein
a cathode terminal of a first diode of the plurality of low-leakage diodes is the first terminal of the input impedance network;
an anode terminal of the first diode is connected to a cathode terminal of a second diode of the plurality of low-leakage diodes; and
an anode terminal of a last diode of the plurality of low-leakage diodes connected in series is the second terminal to the input impedance network.

23. The method according to any of claims 18, 19, 20, and 21, additionally comprising:
connecting a plurality of low-leakage diodes connected in series wherein
an anode terminal of a first diode of the plurality of low-leakage diodes is the first terminal of the input impedance network;
a cathode terminal of the first diode is connected to a cathode terminal of a second diode of the plurality of low-leakage diodes; and
a cathode terminal of a last diode of the plurality of low-leakage diodes connected in series is the second terminal to the input impedance network.

24. The method according to any of claims 18, 19, 20, and 21, additionally comprising:
connecting a first plurality of diodes connected in series wherein
a cathode terminal of a first diode of the first plurality of diodes is the first terminal of the input impedance network;
an anode terminal of the first diode is connected to a cathode terminal of a second diode of the first plurality of diodes; and
an anode terminal of a last diode of the first plurality of diodes is the second terminal to the input impedance network; and
a second plurality of diodes connected in series wherein
an anode terminal of a first diode of the second plurality of diodes is connected to the first terminal of the input impedance network;
a cathode terminal of the first diode is connected to a cathode terminal of a second diode of the second plurality of diodes; and
a cathode terminal of a last diode of the second plurality of diodes is connected to the second terminal to the input impedance network.

25. The method according to any of claims 19 and 21, additionally comprising:
connecting the input impedance network comprising at least two two-terminal sub-networks connected in series wherein
a first terminal of a first sub-network is the first terminal of the input impedance network;
a second terminal of a last sub-network is the second terminal of the input impedance network; and
a sub-network comprises two identical low-leakage diodes connected in parallel and in opposite polarity.

26. The method according to any of claims 19 and 21, additionally comprising:
connecting the MEMS bias network comprising a plurality of low-leakage diodes connected in series wherein
a cathode terminal of a first diode of the plurality of low-leakage diodes is the first terminal of the MEMS bias network;
an anode terminal of the first diode is connected to a cathode terminal of a second diode of the plurality of low-leakage diodes; and
an anode terminal of a last diode of the plurality of low-leakage diodes connected in series is the second terminal to the MEMS bias network.

27. The method according to any of claims 19 and 21, additionally comprising:
connecting a plurality of low-leakage diodes in series wherein
an anode terminal of a first diode of the plurality of low-leakage diodes is the first terminal of the MEMS bias network;
a cathode terminal of the first diode is connected to a cathode terminal of a second diode of the plurality of low-leakage diodes; and
a cathode terminal of a last diode of the plurality of low-leakage diodes connected in series is the second terminal to the MEMS bias network.

28. The method according to any of claims 19 and 21, additionally comprising:
connecting the MEMS bias network comprising:
a first plurality of diodes connected in series wherein
a cathode terminal of a first diode of the first plurality of diodes is the first terminal of the MEMS bias network;
an anode terminal of the first diode is connected to a cathode terminal of a second diode of the first plurality of diodes; and
an anode terminal of a last diode of the first plurality of diodes is the second terminal to the MEMS bias network; and
a second plurality of diodes connected in series wherein
an anode terminal of a first diode of the second plurality of diodes is connected to the first terminal of the MEMS bias network;
a cathode terminal of the first diode is connected to a cathode terminal of a second diode of the second plurality of diodes; and
a cathode terminal of a last diode of the second plurality of diodes is connected to the second terminal to the MEMS bias network.

29. The method according to any of claims 19 and 21, additionally comprising:
connecting the MEMS bias network comprising at least two two-terminal sub-networks connected in series wherein
a first terminal of a first sub-network is the first terminal of the MEMS bias network;
a second terminal of a last sub-network is the second terminal of the MEMS bias network; and
a sub-network comprises two identical low-leakage diodes connected in parallel and in opposite polarity.

30. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier
connecting a first input of a feed-forward bias-voltage-supply circuit to the first terminal of the source resistor;
determining bias in a second input of the feed-forward bias-voltage-supply circuit;
connecting a third input of the feed-forward bias-voltage-supply circuit to main power supply;
connecting a fourth input of the feed-forward bias-voltage-supply circuit to the inverted voltage; and
connecting a first output of the feed-forward bias-voltage-supply circuit to a second terminal of the input impedance network; and
connecting an input electrets capacitor source in parallel to the input impedance network.

31. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier
connecting a first input of a feed-forward bias-voltage-supply circuit to the first terminal of the source resistor;
determining bias in a second input of the feed-forward bias-voltage-supply circuit;
connecting a third input of the feed-forward bias-voltage-supply circuit to main power supply;
connecting a fourth input of the feed-forward bias-voltage-supply circuit to the inverted voltage; and
connecting a first output of the feed-forward bias-voltage-supply circuit to a second terminal of the input impedance network;
connecting a first terminal of a MEMS capacitor to ground,
connecting a second terminal of a MEMS capacitor to a first terminal of a MEMS bias network;
connecting a second terminal of the MEMS bias network to a bias voltage (VBB) generated by the charge-pump;
connecting a first terminal of a coupling capacitor to a second terminal of the MEMS capacitor; and
connecting a second terminal of the coupling capacitor to the gate terminal of the transistor.

32. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier
connecting a first input of a feed-forward bias-voltage-supply circuit to the first (voltage) terminal of the load resistor (RD);
determining bias in a second input of the feed-forward bias-voltage-supply circuit;
connecting a third input of the feed-forward bias-voltage-supply circuit to power supply;
connecting a fourth input of the feed-forward bias-voltage-supply circuit to the inverted voltage;
connecting a first output of the feed-forward bias-voltage-supply circuit to a second terminal of the input impedance network; and
connecting an input electrets capacitor source in parallel to the input impedance network.

33. A method for sensing an acoustic signal, the method comprising:
connecting a first terminal of an input-impedance-network to a gate terminal of a transistor, the transistor comprising at least one of a JFET transistor and a MOSFET transistor;
connecting a first terminal of a source resistor to a source terminal of the transistor;
connecting a second terminal of the source resistor to a ground terminal;
connecting a bypass capacitor (CS) in parallel to the source resistor;
connecting a first terminal of a load resistor (RD) to a drain terminal of the transistor;
connecting a low-voltage (VCC_LOW) terminal of a charge-pump to a second terminal of the load resistor;
connecting an inverted voltage (−VEE) terminal of the charge-pump to a first power supply node of an op amplifier
connecting a first input of a feed-forward bias-voltage-supply circuit to the first (voltage) terminal of the load resistor (RD);
determining bias in a second input of the feed-forward bias-voltage-supply circuit;
connecting a third input of the feed-forward bias-voltage-supply circuit to power supply;
connecting a fourth input of the feed-forward bias-voltage-supply circuit to the inverted voltage;
connecting a first output of the feed-forward bias-voltage-supply circuit to a second terminal of the input impedance network;
connecting a first terminal of a MEMS capacitor to ground,
connecting a second terminal of a MEMS capacitor to a first terminal of a MEMS bias network;
connecting a second terminal of the MEMS bias network to a bias voltage (VBB) generated by the charge-pump;
connecting a first terminal of a coupling capacitor to a second terminal of the MEMS capacitor; and
connecting a second terminal of the coupling capacitor to the gate terminal of the transistor.

34. The method according to any of claims 30, 31, 32, and 33, additionally comprising:
connecting a second terminal of the feed-forward bias-voltage-supply circuit to the charge pump.
